(19) United States
(12) Patent Application Publication
(10) Pub. No.: US 2015/0258531 A1
(43) Pub. Date: Sep. 17, 2015

(54) Method of Making a Nanotube Array Structure

(71) Applicant: UNIVERSITY OF CONNECTICUT, Farmington, CT (US)

(72) Inventors: Pu-Xian Gao, Coventry, CT (US); Zhonghua Zhang, Willimantic, CT (US)

(21) Appl. No.: 14/427,213

(22) PCT Filed: Sep. 13, 2013
(86) PCT No.: PCT/US2013/059727

§ 371 Date: Mar. 10, 2015

Related U.S. Application Data
(60) Provisional application No. 61/701,348, filed on Sep. 14, 2012.

(51) Int. Cl. B01J 23/06; H01B 1/08; B01J 23/10; B01J 23/83; B01J 37/08; B01J 35/00; B01J 35/02; B01J 35/04; B01J 37/02; B82B 3/00; B01J 23/14

(52) U.S. Cl. CPC B01J 23/06; B82B 3/0014; H01B 1/08; B01J 23/10; B01J 23/83; B01J 23/14; B01J 35/004; B01J 35/0006; B01J 35/02; B01J 35/04; B01J 37/0244; B01J 37/0236; B01J 37/08

(57) ABSTRACT

A method of making a nanotube array structure includes forming a nanorod array template on a substrate, coating a nanotube material over the nanorod array template, forming a coated template, annealing the coated template, and drying the coated template. The method then includes heating the coated template to an elevated temperature, relative to ambient temperature, at a heating rate while flowing a gas mixture including a reducing gas over the substrate at a flow rate, the reducing gas reacting with the nanorod array template and forming a gaseous byproduct and the nanotube array structure in which nanotubes may be substantially aligned with adjacent nanotubes. The nanotube array structure can be used, for example, in sensor, catalyst, transistor, or solar cell applications.

### RELATED APPLICATIONS

This application claims the benefit of U.S. Provisional Application No. 61/701,348, filed on Sep. 14, 2012, The entire teachings of this application are incorporated herein by reference.

### GOVERNMENT SUPPORT

This invention was made with government support under Grant #DE-EE0000210 awarded by the U.S. Department of Energy. The Government has certain rights in the invention.

### BACKGROUND OF THE INVENTION

Functional binary and complex metal oxide nanotube arrays (NTAs) have drawn extensive research and development interests in a diverse array of important device applications in energy, environment, sensor and biomedicine, as a result of their distinctive and versatile structural, physical and chemical properties. However, mechanical, structural, and functional compatibility is a long standing issue with regard to these nanotube arrays while interfacing with various substrates such as electrical contact electrodes, buffer layers, and active functional layers. Various templates such as anodized aluminum oxide (AAO), carbon nanotubes (CNT), ZnO nanorod arrays (NRAs) and some monolayer colloidal crystals (MCC) have been employed to synthesize various NTAs. For example, Min et al. used CNT arrays on porous AAO as a template to fabricate ruthenium oxide NTAs. See Y. S. Min, E. J. Bae, K. S. Jeong, Y. J. Cho, J. H. Lee, W. B. Choi and G. S. Park, Adv. Mater., 2003, 15, 1019. They fabricated AAO by a two-step aluminum anodization and then deposited CNT arrays on AAO as a template. After Ru coating on the CNT arrays on AAO, the CNT template was removed by heating. Such a process is too complex and time-consuming. She et al. prepared ZnO NRAs by an electrochemical method and then transformed them into NTAs by selectively etching the (001) planes of ZnO nanorods along the C axis after treatment in acidic or alkaline solutions. See G.-W. She, X.-H. Zhang, W.-S. Shi, X. Fan, J. C. Chang, C.-S. Lee, S.-T. Lee and C.-H. Liu, Appl. Phys. Lett., 2008, 92, 053111. This wet etching method involves precise control over the pH of the solution, and is also limited in its application, because many metal or metal oxide NTAs will dissolve in acidic or alkaline solutions. Lu et al. used ZnO NRAs as a template to fabricate MgO NTAs by a solid-gas chemical reaction route based on the Kirkendall effect. H.-B. Lu, L. Liao, H. Li, D.-F. Wang, Y. Tian, J.-C. Li, Q. Fu, B.-P. Zhu and Y. Wu, Eur. J. Inorg. Chem., 2008, 2727. During the process, the outer diffusion of the ZnO core material through the MgO shells is faster than the in-diffusion of the vapor-phase Mg atoms, resulting in the formation of Kirkendall voids, which eventually induces hollow MgO NTAs. The preparation process is difficult to control accurately and typically leads to the presence of impurities in the formed NTAs. In general, the reported preparation processes often result in NTAs that lack structural integrity, mechanical soundness, and good binding with the interfaced functional substrates, requiring either a replacement with new substrates, or post-process reinforcement. Furthermore, chemical impurities are generally introduced during the template removal processes such as wet chemical etching and thermal decomposition, leading to the degradation of the functionality of the fabricated devices.

Therefore, there is a need for a generic preparation method suitable for preparing nanotube arrays with good mechanical and structural soundness for improving the compatibility of fabricated nanotube arrays with the interfaced device structures and substrates.

### SUMMARY OF THE INVENTION

The invention is generally directed to an in situ temperature-programmed-reduction (TPR) method of making tubular array devices with mechanical and structural soundness and functional robustness on various substrates. In one embodiment, a method of making a nanotube array structure includes forming a nanorod array template on a substrate, coating a nanotube material over the nanorod array template, forming a coated template, annealing the coated template, and drying the coated template. The method then includes heating the coated template to an elevated temperature, relative to ambient temperature, at a heating rate while flowing a gas mixture including a reducing gas over the substrate at a flow rate, the reducing gas reacting with the nanorod array template and forming a gaseous byproduct and the nanotube array structure. In another embodiment, heating the coated template can further include maintaining the coated template at the elevated temperature for a heating time, such as for less than about 5 hours. In one embodiment, the nanorod array template can be a zinc oxide (ZnO) nanorod array template. In another embodiment, the nanotube material can be ceria (CeO₂). In yet another embodiment, the nanotube material can be LaₓSr₁₋ₓCoO₃ (LSCO) (0.01≦x≦0.5).

In one embodiment, the elevated temperature can be in a range of between about 400° C. and about 1,200° C. In another embodiment, the heating rate can be in a range of between about 1° C. and about 25° C. per minute. In yet another embodiment, the gas mixture can include a reducing gas in a range of between about 1 vol % and about 20 vol %, with the balance of the gas mixture being composed substantially of nitrogen. The reducing gas can be hydrogen gas, or, alternatively, carbon monoxide (CO) gas. The flow rate can be in a range of between about 1 sccm and about 100 sccm.

The substrate can be a planar substrate, such as a silicon substrate, or a monolithic substrate, such as a cordierite substrate.

In another embodiment, an apparatus can include a substrate and nanotubes coupled to the substrate, at least a subset of the nanotubes being substantially aligned with adjacent nanotubes. In yet another embodiment, the apparatus can have nanotubes with neighboring alignment. In some embodiments, the nanotubes can be offset from and aligned with adjacent nanotubes. In certain embodiments, the nanotubes can be substantially vertical with respect to the substrate. In some embodiments, the spacing of contact locations of the adjacent nanotubes proximal to the substrate can be closer than a spacing of ends of nanotubes distal from the substrate to form anon-parallel alignment of (i.e., arrangement with) the nanotubes offset from and aligned (i.e., arranged) with the adjacent nanotubes.

Other embodiments can include a sensor, catalyst, transistor, or solar cell made by an embodiment of the above described processes.

Embodiments of this invention have many advantages, such as enabling the fabrication of nanotube arrays with good mechanical and structural soundness for improved compatibility of fabricated nanotube arrays with interfaced device structures and substrates.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1a-1e are: FIG. 1a TPR spectrum of ZnO NRAs on thermally oxidized Si substrate. FIG. 1b XRD patterns of the ZnO NRAs sample before and after TPR process. U-shape sample tube before as shown in FIG. 1c and after TPR process as shown in FIGS. 1d and 1e. FIG. 1e is the closer view for the right side of U-shape tube in FIG. 1d.

FIGS. 2a-2j are photographs of: CeO₂ (FIGS. 2a, 2b, 2c, 2d, 2e) and LSCO (FIGS. 2f, 2g, 2h, 2i, 2j) nanotube arrays on thermally oxidized Si substrates prepared by TPR-template removal method. FIGS. 2a, 2b, 2f, 2g: top view SEM images; FIGS. 2c, 2h: cross-sectional SEM images; FIGS. 2d, 2i: TEM images; FIGS. 2e, j: SAED patterns.

FIGS. 3a-3d are XRD patterns (FIGS. 3a, 3c) and EDX spectra (FIGS. 3b, 3d) of the as-synthesized CeO₂ (FIGS. 3a, 3b) and LSCO (FIGS. 3c, 3d) nanotube arrays on thermally oxidized Si substrates by the TPR-template removal method according to this invention.

FIGS. 4a-4d are SEM images of the LSCO-ZnO samples after different TPR process by holding the temperature at 600° C. for different times by the TPR-template removal method according to this invention.

FIG. 5 is a schematic illustration of the formation of metal oxide NTAs by the TPR-template removal method according to an embodiment of this invention.

FIGS. 6a-6c are: FIG. 6a: a 3D plot of the AFM topography image obtained by scanning the AFM tip with a set point of 0.3 V over a 10 μm×10 μm area of the CeO₂ NTAs on Si substrate. FIG. 6b: SEM images of the CeO₂NTAs after AFM manipulation with a set point of 0.5 V over a 10 μm×10 μm area. FIG. 6c: a zoom-in view of image FIG. 6b.

FIGS. 7a-7e are photographs of: FIG. 7a) a 3D cordierite honeycomb substrate. SEM images of the CeO₂—ZnO composite NRAs before TPR are shown in FIG. 7b and CeO₂ NTAs after TPR are shown in FIG. 7 d on 3D cordierite honeycomb. Images (FIGS. 7c, 7e) are the zoom-in view for FIG. 7b and FIG. 7d.

FIGS. 8a-8e are: FIG. 8a schematic diagram of an O₂ sensor. FIG. 8b O₂ response plot of the CeO₂ NTAs on Si substrate at 800° C. and 10 Hz using modulus (|Z|) as the O₂ sensing signal. FIG. 8c plot of sensitivity and response time vs. lgC_{O2} of the sensor. FIG. 8d UV-vis spectra of Rhodamine B after radiated for 4 hours on ZnO NRAs, CeO₂ NTAs and CeO₂—ZnO composite NRAs. FIG. 8e Plots of −ln(C/C₀) vs. t obtained from the UV-vis absorption spectra of Rhodamine B after radiated on three materials for various time durations.

FIGS. 9a-9d are: FIG. 9a SEM images, FIG. 9b EDX, FIG. 9c TEM and FIG. 9d SAED patterns of the CeO₂/ZnO composite NRAs on the thermal oxidized Si substrate.

FIGS. 10a-10d are: FIG. 10a SEM images, FIG. 10b EDX, FIG. 10c TEM and FIG. 10d SAED patterns of the LSCO/ZnO composite NRAs on the thermal oxidized Si substrate.

FIGS. 11a-11d are: FIG. 11a) EDX, FIG. 11b XRD, FIG. 11c TEM and FIG. 11d SAED patterns of the CeO₂ NTAs on 3D cordierite honeycomb (CH) substrates. As shown in FIG. 11b, the diffraction peaks from CeO₂ were covered by the strong diffraction peaks from the 3D cordierite substrate. As seen from electron diffraction in FIG. 11d, there exist clear diffraction rings from CeO₂ because the interference from the substrate has been eliminated.

FIGS. 12a-12c are: FIG. 12a top view and FIG. 12b tilted (45°) SEM images, and FIG. 12c EDX patterns of the CeO₂ NTAs on the thermal oxidized Si substrate after photocatalysis for 4 hours.

FIG. 13 is a graph of TCD signal (a.u.) as a function of temperature (° C.) illustrating TPR behaviors of ZnO NRAs, LSCO film and LSCO-ZnO composite NRAs on Si substrates.

FIG. 14 are graphs of TCD signal (a.u.) and Gauss Amp signal (a.u.) as a function of temperature (° C.) illustrating the deconvolution of peaks P4 and P5 in FIG. 13.

FIG. 15 is a set of graphs of intensity (a.u.) as a function of 2 Theta (deg) illustrating XRD patterns of blank Si substrate and sputtered LSCO film before and after TPR at 475° C. for 1 hour and at 800° C. for 0 hours.

FIGS. 16a-16b are graphs of Zn content (at %) as a function of FIG. 16a: TPR duration time in hours (h), and FIG. 16b: TPR temperature (° C.) showing the Zn atomic percentage from EDX in the LSCO-ZnO samples after TPR FIG. 16(a) at 600° C. for different time durations, and FIG. 16(b) at different temperatures without duration and for 2 hours.

FIG. 17 are graphs of intensity (a.u.) as a function of 2 Theta (deg) illustrating XRD patterns of LSCO-ZnO NRAs before and after TPR at 800° C. for 2 hours.

FIG. 18 are graphs of intensity (a.u.) as a function of 2 Theta (deg) illustrating XRD patterns of LSCO-ZnO NRAs after TPR at 600° C. for different time durations.

FIG. 19 are graphs of intensity (a.u.) as a function of 2 Theta (deg) illustrating XRD patterns of LSCO-ZnO NRAs after TPR at different temperatures without duration.

FIG. 20 are graphs of intensity (a.u.) as a function of 2 Theta (deg) illustrating XRD patterns of LSCO-ZnO NRAs after TPR at different temperatures for 2 hours.

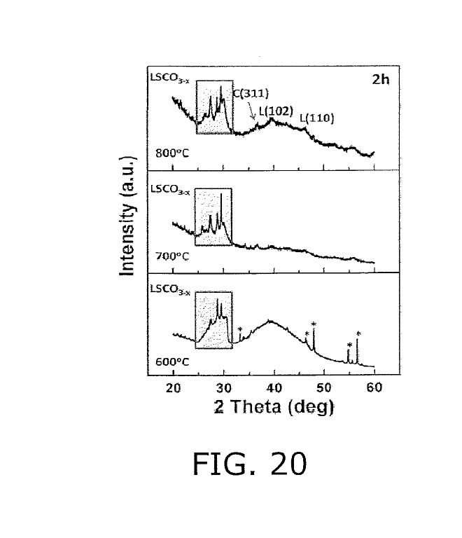

FIG. 21 is a graph of cps as a function of binding energy (eV) illustrating XPS survey spectra of ZnO NRAs, LSCO-ZnO composite NRAs and LSCO NTAs on thermally oxidized Si substrate.

FIGS. 22a-22d are graphs of cps as a function of binding energy (eV) illustrating XPS results of ZnO NRAs, LSCO-ZnO composite NRAs and LSCO NTAs on thermally oxidized Si substrates: FIG. 22a: Zn2p; FIG. 22b: La3d; FIG. 22c: Co2p; FIG. 22d: Sr3d.

FIGS. 23a-23d are photographs of SEM (FIGS. 23a, 23c) and TEM (FIGS. 23b, 23d) images of CeO₂—ZnO composite NRAs (FIGS. 23a, 23b) and CeO₂ NTAs (FIGS. 23c, 23d). The insets in FIGS. 23a and 23c are the cross-sectional SEM images and EDX spectra. The insets in FIGS. 23b and 23d are selected area electron diffraction patterns.

FIGS. 24a-24d are photographs of SEM (FIGS. 24a, 24c) and TEM (FIGS. 24b, 24d) images of SnO₂—ZnO composite NRAs (FIGS. 24a, 24b) and SnO₂ NTAs (FIGS. 24c, 24d). The insets in FIGS. 24a and 24c are the cross-sectional SEM images and EDX spectra. The insets in FIGS. 24b and 24d are selected area electron diffraction patterns.

FIGS. 25a-25d are photographs of SEM (FIGS. 25a, 25c) and TEM (FIGS. 25b, 25d) images of LSCO-ZnO composite NRAs (FIGS. 25a, 25b) and LSCO NTAs (FIGS. 25c, 25d). The insets in FIGS. 25a and 25c are the cross-sectional SEM images and EDX spectra. The insets in FIGS. 25b and 25d are selected area electron diffraction patterns.

FIGS. 26a-26c are graphs of intensity (a.u.) as a function of 2 Theta (deg) illustrating XRD patterns of three series of photo-catalysts: FIG. 26a ZnO NRAs, CeO₂ NTAs and CeO₂—ZnO composite NRAs; FIG. 26b ZnO NRAs, SnO₂ NTAs and SnO₂—ZnO composite NRAs; FIG. 26c ZnO NRAs, LSCO NTAs and LSCO-ZnO composite NRAs.

FIG. 27 is a graph of cps as a function of binding energy (eV) illustrating XPS survey spectra of the ZnO NRAs, CeO₂—ZnO composite NRAs and CeO₂ NTAs on thermally oxidized Si substrate.

FIG. 28 is a graph of cps as a function of binding energy (eV) illustrating XPS survey spectra of the ZnO NRAs, SnO₂—ZnO composite NRAs and SnO₂ NTAs on thermally oxidized Si substrate.

FIG. 29 is a graph of cps as a function of binding energy (eV) illustrating XPS survey spectra of the ZnO NRAs, LSCO-ZnO composite NRAs and LSCO NTAs on thermally oxidized Si substrate.

FIGS. 30a-30c are graphs of absorbance (a.u.) as a function of wavelength (nm) illustrating UV-vis absorption spectra of Rhodamine B after irradiation for various time durations on ZnO NRAs FIG. 30a, SnO₂ NTAs FIG. 30b and SnO₂—ZnO composite NRAs FIG. 30c.

FIGS. 31a-30c are graphs of absorbance (a.u.) as a function of wavelength (nm) illustrating UV-vis absorption spectra of Rhodamine B after irradiation for 4 hours on various samples: FIG. 31a ZnO NRAs, CeO₂ NTAs and CeO₂—ZnO composite NRAs FIG. 31b ZnO NRAs, SnO₂ NTAs and SnO₂—ZnO composite NRAs; FIG. 31c ZnO NRAs, LSCO NTAs and LSCO-ZnO composite NRAs.

FIGS. 32a-32c are graphs of −ln(C/C₀) vs. t obtained from the UV-vis absorption spectra of Rhodamine B after irradiation for various time durations on various samples: FIG. 32a ZnO NRAs, CeO₂ NTAs and CeO₂—ZnO composite NRAs FIG. 32b ZnO NRAs, SnO₂ NTAs and SnO₂—ZnO composite NRAs; FIG. 32c ZnO NRAs, LSCO NTAs and LSCO-ZnO composite NRAs.

FIGS. 33a-33d are graphs of cps as a function of binding energy (eV) illustrating XPS fine spectra of ZnO NRAs, composite NRAs (CeO₂—ZnO, SnO₂—ZnO and LSCO-ZnO), and NTAs (CeO₂, SnO₂ and LSCO). FIG. 33a Zn(2p); FIG. 33b Ce(3d); FIG. 33c Sn(3d); FIG. 33d La(3d).

FIG. 34 is a schematic illustration of the energy band structure of ZnO, CeO₂, SnO₂ and LSCO according to Table 2.

### DETAILED DESCRIPTION OF THE INVENTION

A description of example embodiments of the invention follows.

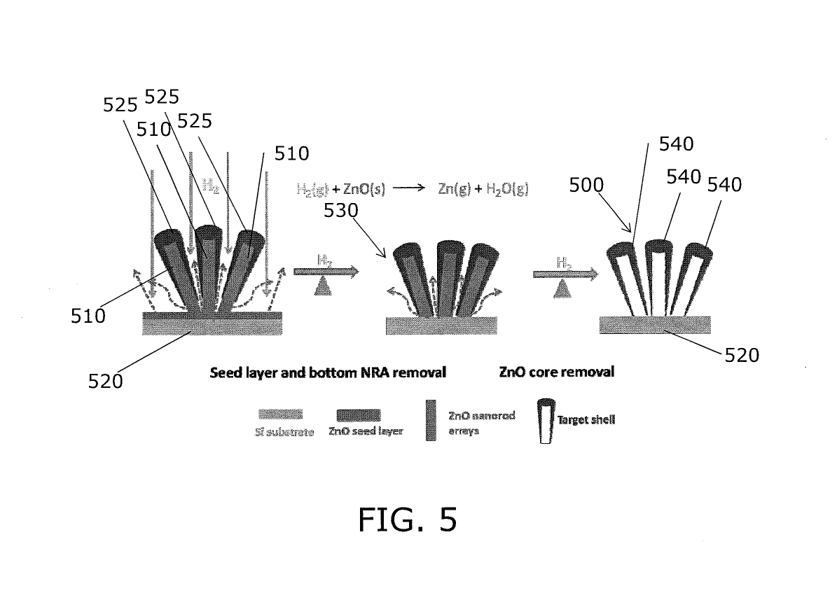

In one embodiment, as illustrated in FIG. 5, a method of making a nanotube array structure 500 includes forming a nanorod array template 510 on a substrate 520, coating a nanotube material 525 over the nanorod array template 510, forming a coated template 530, annealing the coated template, and drying the coated template. The method then includes heating the coated template to an elevated temperature, relative to ambient temperature, at a heating rate while flowing a gas mixture including a reducing gas over the substrate 520 at a flow rate, the reducing gas reacting with the nanorod array template and forming a gaseous byproduct and the nanotube array structure 500. In another embodiment, heating the coated template 530 can further include maintaining the coated template 530 at the elevated temperature for a heating time, such as for less than about 5 hours, for example, for about 2 hours. As used herein, the term “about” includes plus or minus 10% of the nominal listed quantity, unless otherwise specified.

In one embodiment, the nanorod array template 510 can be a zinc oxide (ZnO) nanorod array template. Other template materials can include silver (Ag) or or silver oxide (AgO) nanorod arrays that can be reduced at a temperature of about 120° C., or any nanorod array template material whose oxides are readily reduced at a relatively low temperature and whose corresponding metals are readily evaporated at a relatively low temperature.

In another embodiment, the nanotube material can be ceria (CeO₂). In yet another embodiment, the nanotube material can be LaₓSr₁₋ₓCoO₃ (LSCO) (0.01≦x≦0.5), such as La_{0.8}Sr_{0.2}CoO₃. Other nanotube materials can include nonmetals (such as C, Si, etc.), metals (such as Ti, W, Cu, Fe, Co, Ni, Pt, etc.), metal oxides (such as CeO₂, Al₂O₃, SiO₂, MgO, NiO, Fe₃O₄, Co₃O₄, ZrO₂, etc.), semiconductors (such as TiO₂, SnO₂, WO₃, Ga₂O₃, GaN, SiC, InN, etc.), or complex oxides (such as BaTiO₃, SrTiO₃, LaCoO₃, LaMnO₃, (La,Sr)CoO₃, (La,Sr)MnO₃, LaFeO₃, etc.). The corresponding metals (nano particles) of the nanotube material need to have higher melting points and boiling points than the nanorod array template material.

In one embodiment, the elevated temperature can be in a range of between about 400° C. and about 1,200° C., such as about 800° C. The heating rate can be in a range of between about 1° C. and about 25° C. per minute, such as about 10° C. per minute. The gas mixture can include a reducing gas in a range of between about 1 vol % and about 20 vol %, such as about 10 vol %, with the balance of the gas mixture being composed substantially of nitrogen. The reducing gas can be hydrogen gas, or, alternatively, carbon monoxide (CO) gas. The flow rate can be in a range of between about 1 sccm and about 100 sccm, such as about 25 sccm.

The substrate 520 can be a planar substrate, such as a silicon substrate, or a planar substrate made of Ge, SiO₂, Al₂O₃, Cr₂O₃, GaN, AlN, etc. Alternatively, the substrate can be a monolithic substrate, such as a cordierite substrate, or TiO₂, Al₂O₃, SiO₂, or the like.

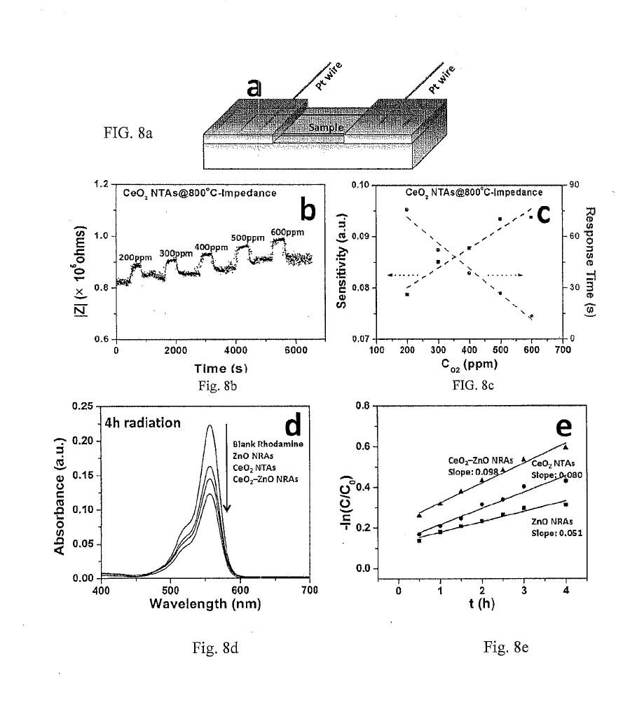

Other embodiments can include a sensor as shown in FIG. 8a, catalyst, transistor, or solar cell made by the above described processes. The as-prepared nanotube arrays can be used for environmental catalysis or photocatalysis, such as CeO₂ nanotube arrays, for sensors such as LaᵢSrₓCoO₃, for solar cells such as TiO₂ nanotube arrays and for solid oxide fuel cells such as Yttrium doped ZrO₂ (YSZ) nanotube arrays.

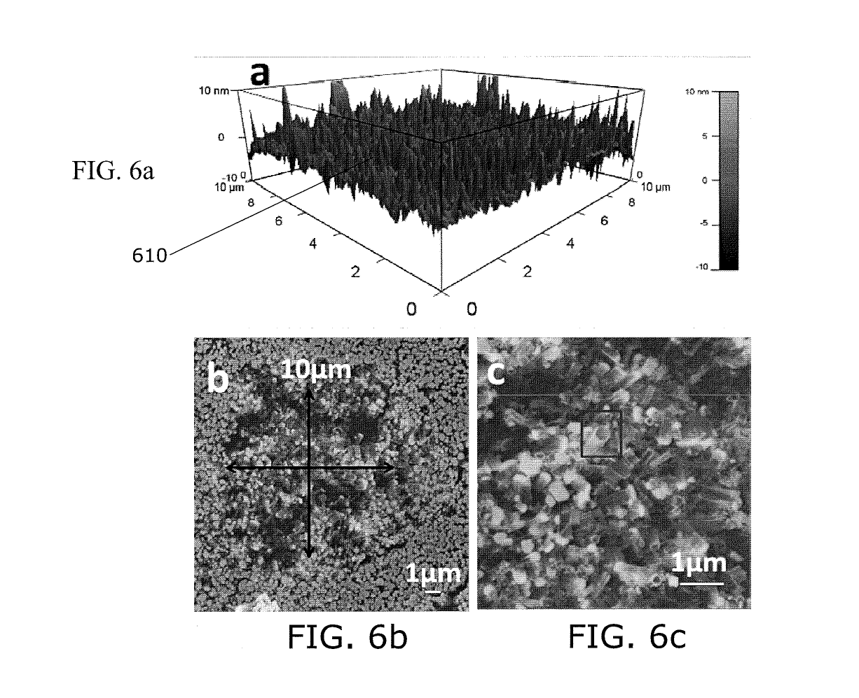

In another embodiment, an apparatus can include a substrate (not shown) and nanotubes 610 coupled to the substrate, at least a subset of the nanotubes being substantially aligned with adjacent nanotubes, as shown in FIG. 6a. As used herein, the term “substantially aligned” means that the nanotubes are spatially offset but also can be in some or full contact with adjacent nanotubes, but in a non-random arrangement. In yet another embodiment, the apparatus can have neighboring offset alignment among the nanotubes. In some embodiments, the nanotubes can be offset from and aligned with adjacent nanotubes. In certain embodiments, the nanotubes can be substantially vertical with respect to the substrate. In some embodiments, as illustrated in FIG. 5, the spacing of contact locations of adjacent nanotubes 540 proximal to the substrate 520 can be closer than a spacing of ends of nanotubes distal from the substrate 520 to form a non-parallel alignment of (i.e., arrangement with) the nanotubes 540 offset from and aligned (i.e., arranged) with adjacent nanotubes.

Wire array templates have previously been utilized for fabricating various three-dimensional tubular structure devices such as solar cells, batteries, supercapacitors, as well as electronic and photonic devices. In these prior approaches, it is necessary for removing the templates to use post-treatments such as wet chemical etching, decomposition, or Kirkendall approaches, however, a challenge arises in order to ensure the tubular structure integrity, mechanical soundness, and chemical purity during the template removal process, and thus the functional robustness of enabled tubular structure array devices. In the work described herein, by utilizing ZnO nanorod array devices as templates, and temperature programmed reduction (TPR) as the removal method, nanotube array devices made of various functional oxides have been directly converted with well-retained uniformity, structural and mechanical soundness, and chemical homogeneity on both two-dimensional (2-D) planar and three-dimensional (3-D) monolith device substrates. The successful examples range from binary metal oxides such as fluorite CeO₂ to complex oxides like perovskite La_{0.8}Sr_{0.2}CoO₃ (LSCO). This TPR removal method is generic, simple and rationally controllable, and can be easily expanded to the preparation of other oxides and non-oxide tubular structure devices regardless of the interfaced device substrate geometry.

The inventors employed ZnO NRA devices as templates and coated the ZnO template with CeO₂ or La_{0.8}Sr_{0.2}CoO₃ (LSCO) film by RF magnetron sputtering and colloidal deposition. The CeO₂ and LSCO NTA devices were obtained by rationally sacrificing a ZnO template under a H₂ atmosphere using temperature programmed reduction (TPR) method. CeO₂ nanotube array O₂ sensors and photocatalytic devices were demonstrated afterwards with good performance and functional robustness.

### Preparation of CeO₂ NTAs and LSCO NTAs on Planar Si Substrate

The ZnO NRAs template were prepared on the thermally oxidized Si(100) substrate by a hydrothermal method. The detailed preparation procedures are described below. Subsequently, the CeO₂ nanofilm of 100 nm was deposited on the ZnO NRAs template with a deposition rate of about 1 Å per 30 seconds by RF magnetron sputtering at a power of 25 Win 7.36×10⁻³ Torr of argon plasma. The LSCO nanofilm of 100 nm was also sputtered on the ZnO NRAs template using the same conditions except that the sputtering power was 15 W. After sputtering, the CeO₂—ZnO and LSCO-ZnO samples were annealed at 500° C. and at 800° C. for 3 hours, respectively. The CeO₂ NTAs and LSCO NTAs were obtained by a TPR method (ChemiSorb 2720 Pulse Chemisorption System, Micromeritics Instrument Corporation) under hydrogen atmosphere. First, the composite NRAs were dried at 150° C. under N₂ flow with a flow rate of 25 sccm. Then 10 vol % H₂ in N₂ with a flow rate of 25 sccm was fed through the sample cell. In the case of CeO₂ NTAs, the TPR temperature changed from room temperature to 800° C. with a ramping rate of 10° C. min⁻¹. In the case of LSCO NTAs, the heating program is the same but held at 800° C. for 2 hours. After cooling in N₂ atmosphere, the CeO₂ and LSCO NTAs on Si substrate were obtained. The CeO₂ NTA was further annealed at 500° C. for 3 hours in air.

### Preparation of CeO₂ NTAs on 3D Monolith

A ZnO seed layer was prepared on the monolith channel walls using the alternative dip-coating (ZnAc₂ in ethanol solution) and annealing process. Subsequently, the ZnO nanorod arrays were grown on the substrate with a ZnO seed layer by a hydrothermal process. The CeO₂—ZnO composite NRAs on the cordierite honeycomb was prepared by in situ deposition of CeO₂ nano-layer on ZnO nanorod array. The detailed preparation procedures are described below. Finally, the same TPR procedure ramping from room temperature to 800° C. under 10 vol % H₂ in N₂ was applied to the preparation of the CeO₂ NTAs on 3D substrate.

### Morphological and Structural Characterizations

Morphology, crystallography and elemental composition were performed with a JEOL 6335F field emission scanning electron microscope (FESEM) attached with a Thermo Noran EDX detector and Tecnai T12 transmission electron microscopy. For the SEM, a thin layer of PdAu film was coated onto the samples in order to avoid the charging effect of the samples. X-ray diffraction (XRD) was performed using a Bruker D8 Advance X-ray diffractometer equipped with a Cu Kα (k=1.5405 Å) as radiation source operating at 40 kV and 40 mA. Atomic Force Microscopy (AFM) was carried out with Asylum Research Molecular Force Probe 3D.

### Sensor Test

The CeO₂ nanotube array sample was placed onto a ceramic testing stage. Two thin platinum wires were used as electrical leads to form a good ohmic contact with the device electrodes. The sensor testing stage with wires and sample is shown in FIG. 8a. To test the sensing performance, the sensor testing stage with CeO₂ sample and Pt wires were loaded into an alumina tube of a sealed tube furnace with gas flow and control system. The test temperature of the tube furnace was set at 800° C. The concentrations of O₂ with N₂ as balance gas were controlled with an Environics series 4000 gas mixing station. The electric signals were measured and recorded continuously by a CHI 660D electrochemical workstation when the pre-diluted gases (nitrogen was used as balance gas) were sent to the sensor testing chamber. The recovery of the gas sensors was accomplished by flushing with nitrogen.

### Photocatalysis Test

Prior to irradiation, the samples (ZnO NRAs, CeO₂ NTAs and CeO₂—ZnO composite NRAs) were immersed into 0.001 mg ml⁻¹ of Rhodamine B aqueous solution and placed in the dark for 30 min to establish an adsorption/desorption equilibrium. The solution containing the samples were subsequently irradiated using a Luzchem ring illuminator with UV light (310-400 nm, peak at 356 nm). The concentrations of Rhodamine B in the supernatant were monitored and analyzed by measuring the absorbance at 557 nm wavelength using a Perkin Elmer Lambda 900 UV/VIS/near IR Spectrometer.

### Results and Discussion

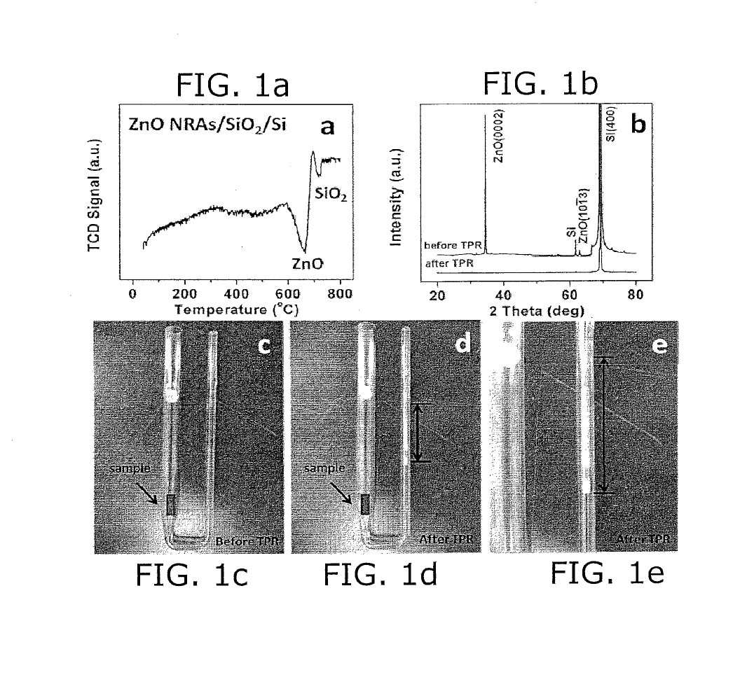

FIG. 1a shows a typical TPR spectrum of ZnO NRA devices on thermally oxidized Si substrate. A strong reduction peak was observed corresponding to ZnO in the range of 580-700° C. The characteristic diffraction peaks (0002) and (10 1̅3) from ZnO disappeared after the TPR process, as revealed in the X-ray diffraction (XRD) spectrum (see FIG. 1b). In addition, macroscopically, the original ZnO NRAs sample surface is initially coarse and grey. After TPR process, the sample surface looks shiny and only exhibits the pink color of blank thermally oxidized Si substrate. Meanwhile, the inventors also found that the right side of the originally clean and transparent U-shape quartz sample tube (see FIG. 1c) turned into white, clearly deposited with a layer of white film after TPR process (see FIGS. 1d and 1e). Evidently ZnO NRAs were completely reduced to Zn during the TPR process under 10% H₂ (Eq. 1).

H₂(g)+ZnO(s)→Zn(g)+H₂O(g) (1)

It is worth pointing out that the low melting point of Zn (about 419.5° C.) will lead to a liquid-form Zn flux at 419.5° C. or above during the temperature ramping of the TPR process. On the other hand, the high vapor pressure of Zn could easily enable the vaporization (or sublimation) of Zn on the surface to be carried away gradually by the H₂/N₂ atmosphere to the downstream side of the U-type sample tube and condensed there until the ZnO disappears completely(about 907° C.). Based on this property of ZnO during the TPR process, the inventors used ZnO NRA devices as templates and applied a TPR process to prepare metal oxide NTA devices. As described below, the inventors took binary fluorite CeO₂ and quaternary perovskite La_{0.8}Sr_{0.2}CoO₃ (LSCO) as examples to demonstrate this TPR-template removal method.

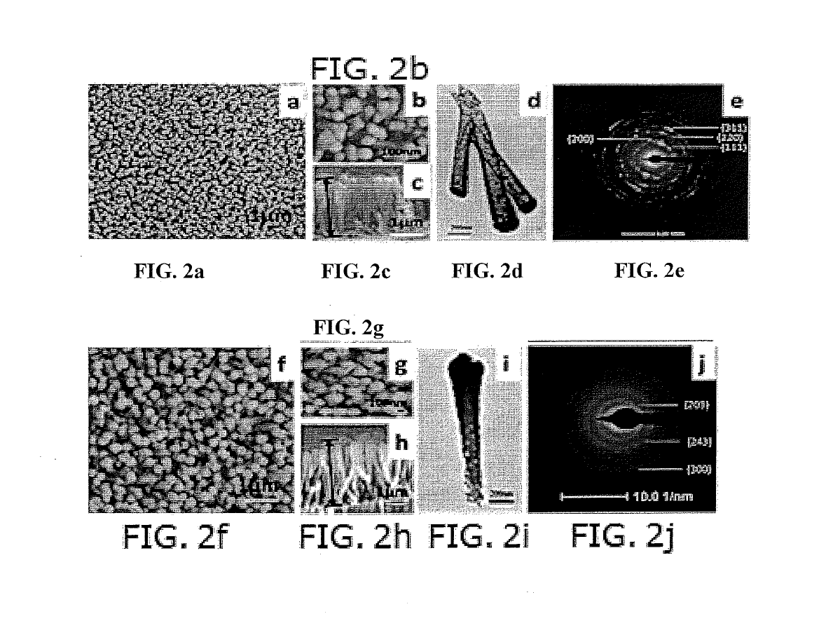

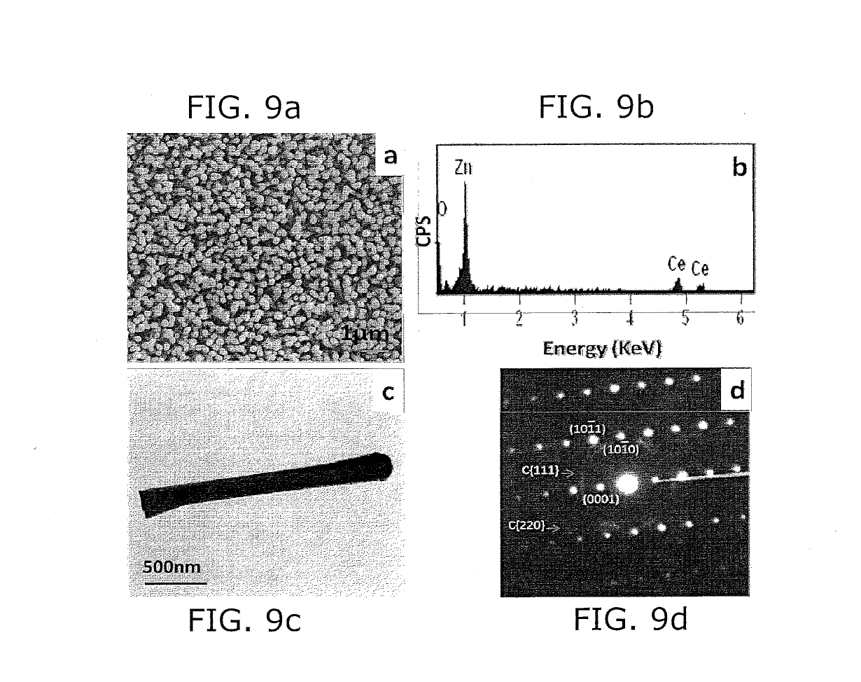

CeO₂, as a rare earth oxide with a fluorite cubic structure, has widespread applications such as automotive catalysts, electrodes for sensors, oxygen conductors in solid oxide fuel cells, ultraviolet blocking components in cosmetics and abrasives in chemical-mechanical planarization. FIGS. 2a, 2b, 2c, 2d and 2e display the morphology and structure of the as-synthesized CeO₂ NTAs on SiO₂/Si substrates using this TPR template removal method. Densely packed and well-aligned CeO₂ NTAs were uniformly converted at a large scale (see FIG. 2a). The grown NTAs after the TPR process clearly have retained the same structure integrity and distribution as the CeO₂/ZnO composite NRAs (shown in FIG. 9). Big round tips of about 200 nm in diameter were observed (FIG. 2b) from individual CeO₂ nanotubes due to the shadow effect induced by over-deposition of CeO₂ on top of ZnO NRAs. The about 1.7 μm high CeO₂ NTAs are aligned perpendicularly to the SiO₂/Si substrate (see FIG. 2c). The tubular structure of the CeO₂ NTAs was confirmed by TEM imaging (see FIG. 2d), with an outer diameter of about 250 nm and an inner diameter of about 160 nm, and a wall thickness of about 60 nm. The selected area electron diffraction (SAED) pattern in FIG. 2e revealed the characteristic rings corresponding to {111}, {200}, {220} and {311} atomic planes of CeO₂, indicating the polycrystallinity of the CeO₂ nanotubes, with a fluorite cubic structure (JCPDF #43-1002). Unlike the SAED of the CeO₂—ZnO composite NRAs (shown in FIG. 9), the single-crystal diffraction spots corresponding to ZnO disappeared completely. This indicates that the ZnO template has been removed, which is further confirmed by the EDX and XRD results described below.

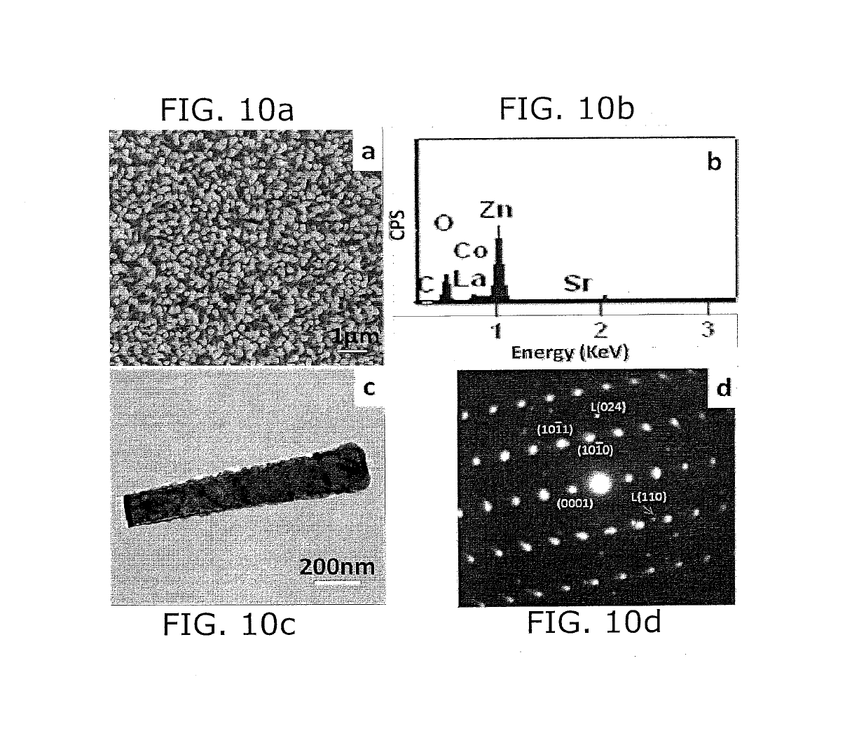

LSCO, a perovskite-type metal oxide, has wide application in automobile catalysis, fuel cells, photocatalysis, photodiodes and chemical sensing, and magnetic devices. FIGS. 2f-2j show the converted LSCO NTAs using this TPR template removal method with high packing density and good alignment throughout the 1 cm by 1 cm entire surface of SiO₂/Si substrate (see FIG. 2f). FIG. 2g indicates that all the nanotubes have big tips from LSCO coating, with an average diameter of about 280 nm. The length of the NTAs is about 1.5 μm (see FIG. 2h). As such, the TEM image in FIG. 2i confirms the tubular LSCO nanostructures, which have round tips with about 300 nm in diameter, an outer diameter of about 150 nm and a wall thickness of about 50 nm. The SAED ring pattern in FIG. 2j identifies the polycrystalline nature of La_{0.8}Sr_{0.2}CoO₃₋ₓ (LSCO₃₋ₓ) {203} and {243} (JCPDF #00-46-0704), and La₂O₃ {300} (JCPDF #05-0602). The existence of LSCO₃₋ₓ and La₂O₃ results from the reduction of LSCO in the H₂ reductive environment, which is explained in detail in the XRD analysis below. Distinct from the SAED ring pattern in the LSCO-ZnO composite NRAs (shown in FIG. 10), a strong set of single-crystal diffraction spots from the wurtzite ZnO NRAs disappeared completely. See D. Jian, P.-X. Gao, W. Cai, B. S. Allimi, S. P. Alpay, Y. Ding, Z. L. Wang and C. Brooks, J. Mater. Chem., 2009, 19, 970; H. Gao, W. Cai, P. Shimipi, H.-J. Lin and P.-X. Gao, J. Phys. D: Appl. Phys., 2010, 43, 272002.

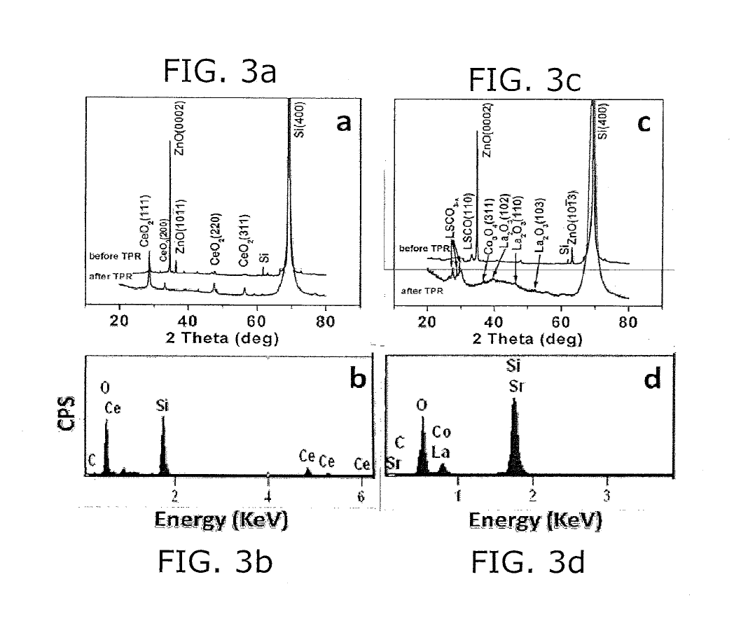

FIGS. 3a and 3b display the typical XRD and EDX spectra of CeO₂ NTAs, respectively. As seen from XRD patterns, there are no diffraction peaks after TPR (JCPDF #36-1451), while CeO₂ diffraction peaks remain visible including (111), (200), (220), and (311). It is also found from the EDX result that there is no Zn signal from the ZnO template, indicating that the ZnO template has been removed completely after TPR. The XRD and EDX results further confirmed this conclusion. FIGS. 3c and 3d show the XRD and EDX of LSCO NTAs. There is a LSCO (110) peak beside the ZnO diffraction peaks before TPR. After TPR, the diffraction peaks from ZnO disappear, with retained LSCO₃₋ₓ peaks, and some very weak peaks from Co₃O₄ and La₂O₃. The formation of LSCO₃₋ₓ is due to the removal of the lattice oxygen from the LSCO crystal in the reductive environment (Eq. 2). See H. Tanaka and M. Misono, Curr. Opin. Solid State Mater. Sci., 2001, 5, 381. The presence of Co₃O₄ and La₂O₃ is due to the decomposition of the perovskite structure at high temperature in the reductive environment (Eq. 3). After annealing at high temperature in air, this NTA device successfully recovered its LSCO stoichiometry with perovskite structure.

$$\begin{matrix}{La}_{1 - x}^{3 +} {Sr}_{x}^{2 +} + {Co}_{1 - x}^{3 +} {Co}_{x}^{4 +} {O}_{3} + δ {H}_{2} \to {La}_{1 - x}^{3 +} {Sr}_{x}^{2 +} {Co}_{1 - x + 2 δ}^{3 +} {O}_{3 - δ} + δ {H}_{2} O & ( 2 ) \\ {La}_{1 - x}^{3 +} {Sr}_{x}^{2 +} + {Co}_{1 - x}^{3 +} {Co}_{x}^{4 +} {O}_{3} + \frac{1 + 3 x}{6} {H}_{2} \to \frac{1 - x}{2} {La}_{2} {O}_{3} + xSrO + \frac{1}{3} {Co}_{3} {O}_{4} + \frac{1 + 3 x}{6} {H}_{2} O & ( 3 )\end{matrix}$$

EDX results also show that there is La, Sr, Co and O signal but no Zn signal in the sample, which indicates that ZnO template has been removed completely. Based on the above analysis, the inventors conclude that the CeO₂ NTAs and LSCO NTAs have been successfully formed on the planar SiO₂/Si substrates.

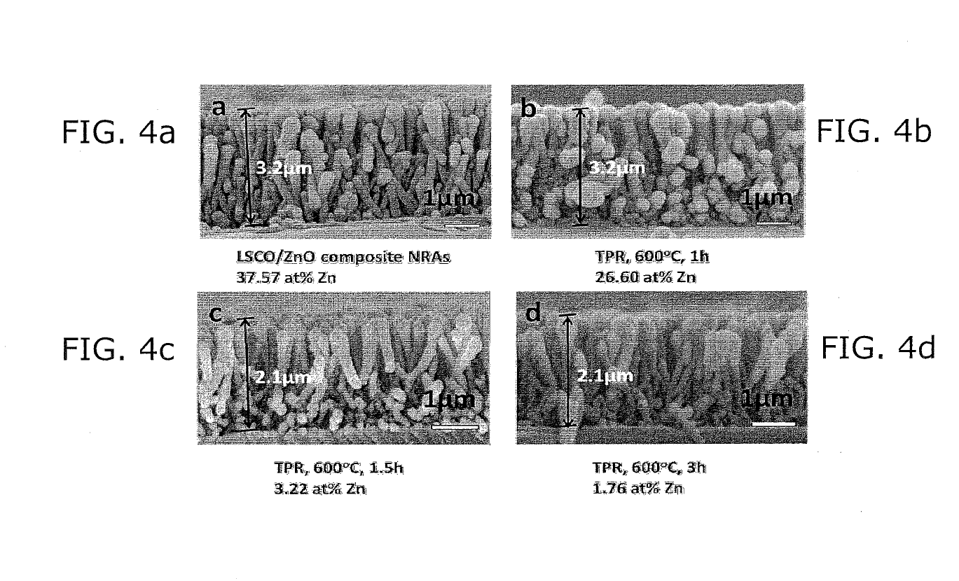

To understand the formation process of the NTAs during the TPR process, the inventors carried out different TPR treatments on the LSCO-ZnO composite NRAs by holding the temperature at 600° C. for different time durations. First, it was found from EDX measurements that the as-prepared LSCO/ZnO composite NRAs have a Zn content of 37.57 at %, while the samples after the TPR treatment at 600° C. for 1 hour, 1.5 hours and 3 hours have Zn contents of 26.60 at %, 3.22 at % and 1.76 at %, respectively. The inventors found that there is an abrupt change in Zn content from 1 hour to 1.5 hours. Second, the inventors investigated the cross-sectional morphology change of the samples after different TPR treatments. As shown in FIG. 4, the as-prepared composite NRAs have a length of 3.2 μm (see FIG. 4a). After the TPR treatment for 1 hour, the NRAs still have a length of about 3.2 μm. However, after further TPR at 600° C. for 1.5 and 3 hours, the NRAs have lengths of about 2.1 μm and about 2.1 μm, respectively. By the combination of EDX and cross-sectional SEM analysis, the inventors found that before the TPR treatment at 600° C. for 1.5 hours, there is only some minor reduction of ZnO on the composite NRAs. With the treatment time extended to 1.5 hours, the ZnO was further removed from the bottom of the NRAs and thus the height of the NRAs was shortened. This means that when the sputtering method is used to coat the ZnO with LSCO, the lower section of the ZnO NRAs is not fully covered with LSCO due to the shadow effect during sputtering. With further TPR treatment, the ZnO inside the composite NRAs was completely removed through the open bottom of the NRAs.

The formation mechanism of NTAs is summarized in the schematic diagram illustrated in FIG. 5. Two major steps are thought to be involved in the TPR process. First, the gaps between adjacent nanorods allow H₂ gas to preferentially arrive and be exposed to the ZnO seed layer surface and uncoated bottom ZnO NRAs surface, and to react with ZnO and form liquid state Zn (above 420° C.), which will be carried away by the flowing gas after partial sublimation and vaporization at high temperature, and thus to remove the seed layer and the bottom section of ZnO NRAs, leading to the shortening of composite NRAs. In the second step, with the bottom of composite NRAs having been opened in the first step, H₂ will react rapidly with the ZnO core and form the hollow structure.

To investigate the mechanical soundness of the in-situ converted nanotube array devices on SiO₂/Si substrate, the inventors used atomic force microscopy (AFM) tips to press the nanotube arrays and then observed the morphology change under SEM. See P.-X. Gao, J. Song, J. Liu and Z. L. Wang, Adv. Mater., 2007, 19, 67. In contact mode, a smaller set bias in AFM represents a smaller force applied on the samples. When the set bias in the AFM was 0.3 V, the nanotube array structure remained intact, as revealed in the AFM image (see FIG. 6a). When the bias was increased to 0.5 V, the nanotube arrays started to get pulled and deformed. As shown in FIG. 6b, most of the nanotubes tilted, with hexagonal openings clearly observed in FIG. 6c. SEM imaging after AFM manipulation also showed that the TPR-induced nanotube arrays were mostly intact after the AFM manipulation. It is worth pointing out that despite the partial deposition coverage of CeO₂ and LSCO using the sputtering method, the mechanical soundness of NTAs shown here is very good, possibly due to the strong Van der Wals force interaction between the substrates and the shortened nanotube arrays.

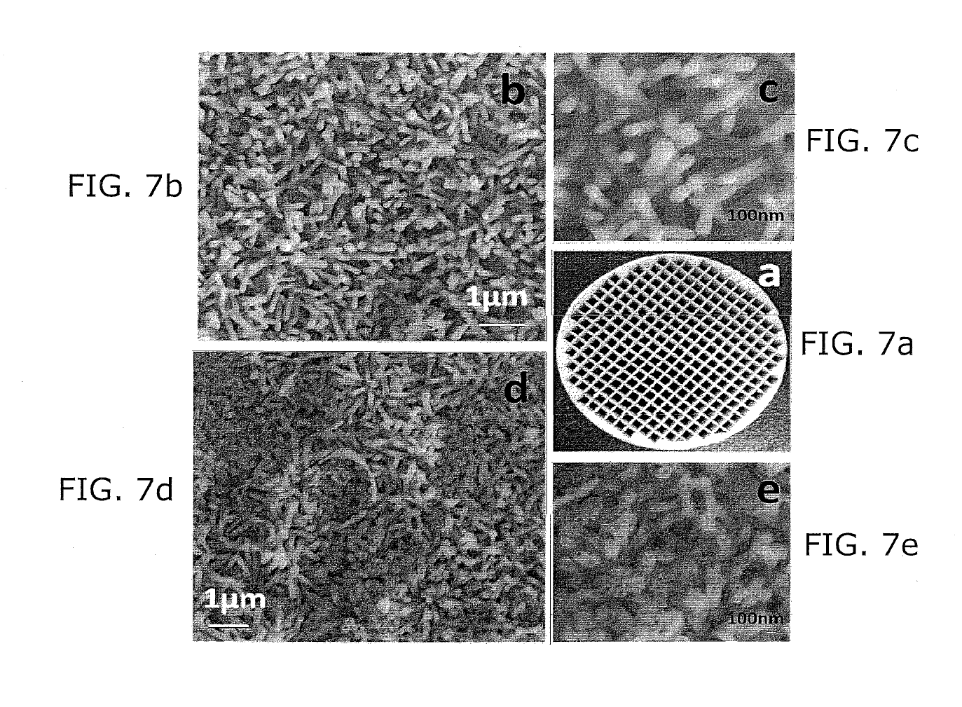

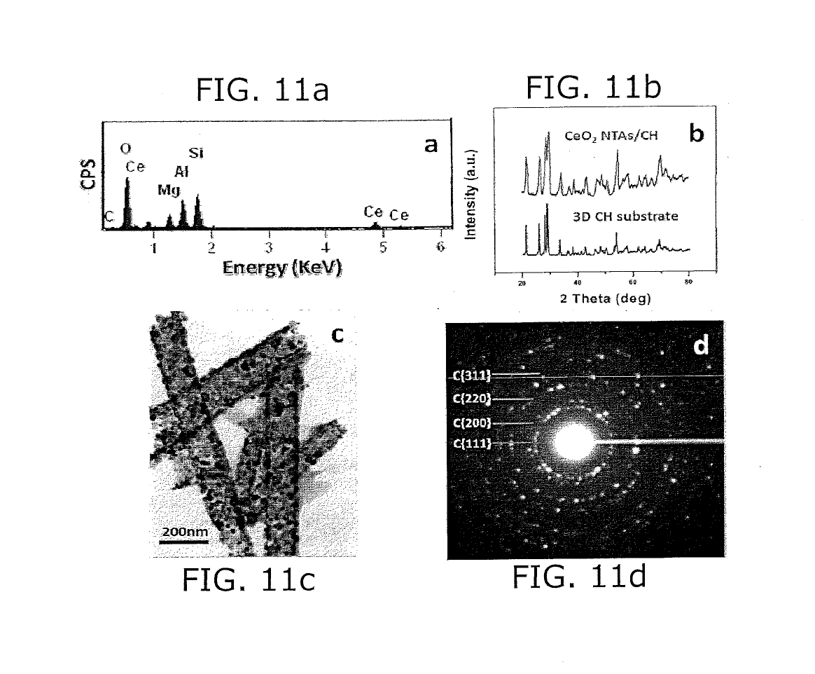

After the successful fabrication of CeO₂ and LSCO nanotube arrays on planar substrates, the inventors further expanded the TPR-template removal method to the preparation of nanotube arrays on three dimensional (3-D) monolith substrates. FIG. 7 shows a photograph of the 3D cordierite honeycomb substrate and the SEM images of CeO₂—ZnO composite NRAs before TPR and CeO₂ NTAs after TPR on a 3D cordierite monolith substrate. Other characterizations of the CeO₂ NTAs on 3D cordierite honeycomb substrates such as XRD, EDX and TEM are shown in FIG. 11. The cordierite honeycomb with 1 mm×1 mm square holes is 2.5 cm wide and 1.0 cm long (see FIG. 7a). As seen from FIG. 7b, the CeO₂—ZnO composite NRAs distribute uniformly on the cordierite honeycomb. The composite rods of about 150 nm width (see FIG. 7c) turned into nanotube arrays after the TPR process (see FIG. 7d) with similar size to the rods with open ends (see FIG. 7c), distinct from the CeO₂ and LSCO NTAs on SiO₂/Si substrates as shown in FIG. 2. This is due to the different preparation method of the CeO₂ coating on the ZnO NRAs. In the case of the planar SiO₂/Si substrates, the inventors employed the sputtering method to deposit a CeO₂ coating on ZnO NRAs, which deposits the film from up to down and therefore tends to form a big head due to the shadow effect. In the case of the cordierite honeycomb, the inventors employed the hydrothermal method to deposit CeO₂ coating onto the ZnO NRAs. Ce³⁺ ions in this chemical method tend to adsorb on the side surfaces along the c-axis rather than on the top surfaces of the ZnO NRAs. See Y. S. Chen and T. Y. Tseng, Adv. Sci. Lett., 2008, 1, 123. This led to the open ends of the CeO₂ NTAs after the TPR ZnO removal.

As stated earlier, to directly convert nanorod array devices into nanotube array devices without compromising the structural and functional soundness is a challenge, although an electronic device will not need a secondary electrode deposition if the nanotube array device can be directly converted from a nanorod array device. Herein, the inventors demonstrated that a CeO₂ NTAs sensor device could be directly converted from the composite nanorod array device using a TPR process. The electrochemical impedance technique was employed to detect the O₂ atmosphere with different O₂ concentrations down to a ppm level. See L. Y. Woo, R. S. Glass, R. F. Novak and J. H. Visser, J. Electrochem. Soc., 2010, 157, J81. FIG. 8 shows the schematic structure of a tubular NTAs sensor device (see FIG. 8a) and the O₂ sensing behaviors of the CeO₂ NTAs on SiO₂/Si substrate at 800° C. and 10 Hz, using impedance modulus as the sensing signal. The modulus of the CeO₂ NTAs increases with the introduced O₂ gas concentration (see FIG. 8b), as a result of the decrease in CeO₂ conductivity. See P. Jasinski, T. Suzuki and H. U. Anderson, Sensor Actuat. B, 2003, 95, 73. The sensitivity exhibits a linear relationship with the O₂ concentration. The response time at 200 ppm, 300 ppm, 400 ppm, 500 ppm and 600 ppm O₂ are 75 seconds (s), 52 s, 38 s, 27 s and 13 s, respectively (see FIG. 8c). Therefore, a high sensitivity and rapid response 0₂ sensor was demonstrated using the directly converted CeO₂ nanotube array device. Moreover, only minor structural change was observed in the CeO₂ NTAs sensor in the morphology, structure and functions after two days of continuous testing, which revealed good functional robustness.

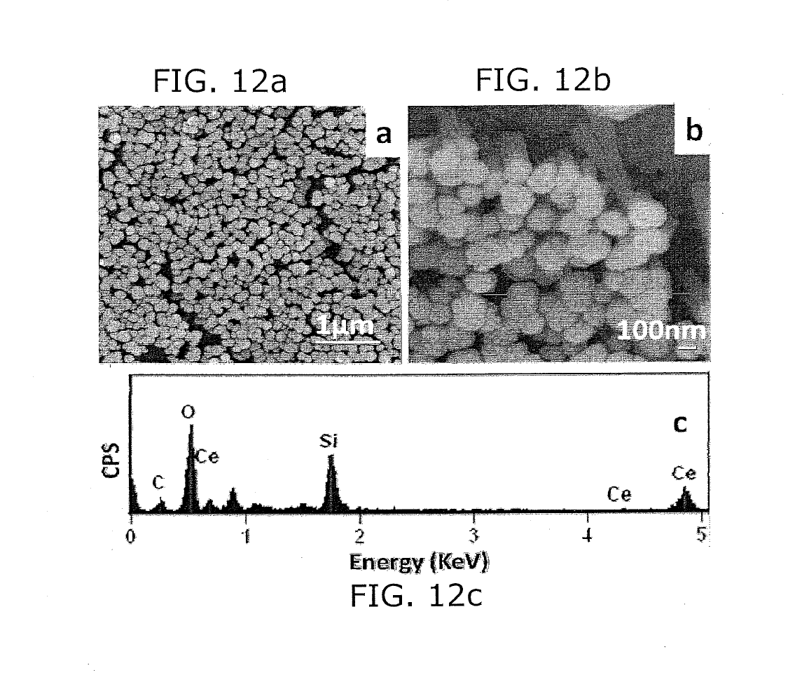

Heterogeneous photocatalysis is an attractive approach for the removal of inorganic and organic pollutants in air and water. See M. R. Hoffmann, S. T. Martin, W. Choi and D. W. Bahnemann, Chem. Rev., 1995, 95, 69; M. A. Fox and M. T. Dulay, Chem. Rev., 1993, 93, 341. Here, the TPR enabled nanotube arrays with an integral structure and mechanical soundness interfaced with device substrates provides an opportunity to decouple the respective functions and corresponding contributions of each composition in the original composite NRAs before TPR removal. Herein, the inventors chose Rhodamine B (RB) as a representative of organic pollutants to evaluate the photocatalytic performance of CeO₂ nanotube arrays for environmental applications. FIG. 8d shows the UV-vis spectra of RB after irradiation for 4 hours on the ZnO NRAs, CeO₂ NTAs and CeO₂—ZnO composite NRAs. The absorbance of RB is 0.22 without catalysts, 0.16 for the ZnO NRAs, 0.14 for the CeO₂ NTAs, and 0.12 for the CeO₂—ZnO composite NRAs, respectively. These results clearly demonstrate that the CeO₂—ZnO composite NRAs have a better photo-catalytic performance for the degradation of RB than the corresponding individual material. As seen from the kinetic results in FIG. 8e, the linear relationship of −ln(C/C₀) vs. t suggests that the degradation of RB on the three materials follows first order reaction kinetics. It can be found from the slopes of the lines that the rate constants for the degradation of RB are 0.051 h⁻¹ for the ZnO NRAs, 0.080 h⁻¹ for the CeO₂ NTAs, and 0.098 h⁻¹ for the CeO₂—ZnO composite NRAs, respectively. However, considering that the active mass of the ZnO NRAs, CeO₂ NTAs and CeO₂—ZnO composite NRAs on Si substrates are 0.54 mg, 0.075 mg and 0.615 mg, respectively, the specific rate constants are 1.57 min⁻¹ g⁻¹ catalyst for the ZnO NRAs, 21.78 min⁻¹ g⁻¹ catalyst for the CeO₂ NTAs, and 2.17 min⁻¹ g⁻¹ catalyst for the CeO₂—ZnO composite NRAs, respectively. By comparing the specific rate constants, one can conclude that the CeO₂ NTAs have a much better photocatalytic performance for the degradation of dyes. In addition, it was also found, as shown in FIG. 12, that the CeO₂ NTA device retained an intact structure with a similar composition as the original CeO₂ NTAs after the instantaneous photocatalysis test for 4 hours.

### Conclusions

In summary, CeO₂ and LSCO nanotube array devices, for example, have been directly converted from the nanorod array device templates on 2D and 3D substrates by a temperature programmed reduction template removal method. This method is generic and controllable in converting metal oxide NTA devices directly from metal oxide NRA devices with good mechanical and structural soundness, as well as functional robustness. The diameter and wall thickness of NTAs can be controlled by adjusting the diameter of NRA template and the coating thickness of target metal oxide materials. The TPR removal process can be monitored and controlled, which can be expanded to be applied to other functional oxide and non-oxide tubular structure devices as well as in catalysis, batteries, electronics, photonics and sensors.

### Temperature Programmable Reduction Method Merits:

Controllable (temperature, time, atmosphere)

Simple chemistry

In-situ conversion

Structure integrity and adjustability

Flexible device substrate shape

Ease of hatch production design and optimization

### Applications and Technology Readiness

### Device Structure Merits:

Mechanical soundness

In-situ device platform→Saving transfer integration step

Materials usage efficiency and device structure controllability

### Device Structure Categories:

2D platform—Si based electronics, etc.

3D platform like monoliths or other complicated types of platforms

Tubular structure device platform: sensors, catalysts, transistors, solar cells, light emitting diodes, coatings, etc.

### Technology Readiness*:

Materials dependence→Understanding the chemistry (TRL1-2)

Various device in-situ conversion and function demonstration (TRL3-6);

Batch production process/instrumentation design and optimization (TRL5-7);

Mass production process feasibility and cost-effectiveness (TRL6-9).

* TRL refers to “Technology Readiness Level”—a measure of the stages of development/maturity of evolving technologies.

### Competing Technologies

AAO template removal (strong acids, e.g., HF)

Wet etching (acids, e.g., HCl and H₂SO₄)

### TPR's Merits Over the Above Technologies:

Better mechanical soundness and structure integrity

Good adaptability in both 2D and 3D platform like monoliths or other complicated types of platforms

In-situ process saves the transfer step in device fabrication

Better stoichiometry and chemistry controllability and tunability

Good scalability and flexible device substrate choices

More broad and diverse spectrum of tubular structure devices: sensors, catalysts, transistors, solar cells, light emitting diodes, coatings, etc.

### Experimental Section

### Preparation of ZnO, CeO₂—ZnO and LSCO-ZnO Composite NRAs on Planar Si Substrates

Before growth, a ZnO seed layer of 30 nm was deposited onto the thermally oxidized Si(100) substrate by RF magnetron sputtering (Torr International, Inc.) and annealed at 600° C. for 2 hours. The ZnO NRAs were further grown on the substrate using a hydrothermal method. In a typical hydrothermal synthesis, the Si substrate with ZnO seed layer was attached onto a cap and floated in a container filled with 25 mL of zinc acetate (ZnAc₂, 0.02 mol L⁻¹) and hexamethylenetetramine (HMT, 0.02 mol L⁻¹). Subsequently, the container was sealed and placed in a water bath. Growth was carried out at 90° C. for 5 hours. Finally, the sample was cleaned several times with DI water and dried at 80° C. overnight, forming the template.

The CeO₂ and LSCO nanofilms of about 100 nm were deposited on the ZnO NRAs template by RF magnetron sputtering. Both films were sputtered in 7.38×10⁻³ Torr of argon plasma. After sputtering, the CeO₂—ZnO and LSCO-ZnO samples were annealed at 500° C. and at 800° C. for 3 hours, respectively.

### Preparation of the CeO₂—ZnO Composite NRAs on 3D Cordierite Honeycomb

The CeO₂—ZnO composite NRAs on the cordierite honeycomb were prepared by in situ deposition of a CeO₂ nano-layer on a ZnO nanorod array. ZnO nanorod growth was accomplished by a typical hydrothermal process. Equal molar zinc nitrate hexahydrate (Zn(NO₃)₂.6H₂O) and hexamethylenetetramine (C₆H₁₂N₄, HMT) (25 mM) were dissolved in 200 mL DI water as a precursor solution. The substrate was then put in the prepared precursor solution to grow ZnO nanorods. After 2 hours growth of ZnO nanorod arrays at 75° C., cerium nitrate hexahydrate (Ce(NO₃)₃.6H₂O, 125 mM) was then added into the solution. After rinsing and drying, the ZnO—CeO₂ core-shell nanorod arrays were obtained on the 3D cordierite substrate.

### EXEMPLIFICATION

### Example 1

Thermal Stability of (La,Sr)CoO₃—ZnO Composite Nanorod Arrays under Reducing Atmosphere

ZnO nanorod arrays (NRAs) and La_{0.8}Sr_{0.2}CoO₃ (LSCO)-ZnO composite NRAs have been prepared on Si substrates using hydrothermal and magnetron sputtering methods. Temperature programmed reduction (TPR) technique is employed to investigate their thermal stability under strong reducing atmosphere. The LSCO shells in the composite NRAs exhibit high chemical stability and are found to just lose lattice oxygen and produce oxygen vacancies at high temperature, which leads to the transition of the crystal symmetry from Rhombohedral LSCO to Orthorhombic LSCO₃₋ₓ. However, the ZnO cores are much easier to be removed during TPR process, which leads to the formation of LSCO nanotube arrays. The good correlation between XPS and TPR indicates that there exists strong interaction between ZnO cores and LSCO shells in the composite NRAs, which decreases the thermal stability of ZnO NRAs, suppresses the release of lattice oxygen in LSCO at low temperature, and accelerates the decomposition of LSCO structure at high temperature under reducing atmosphere. The presence of lattice oxygen (or oxygen vacancies) in LSCO and strong interaction between ZnO cores and LSCO shells are very promising for designing highly efficient composite catalysts, while the removal of ZnO cores during TPR process provides an opportunity for the preparation of various metal and metal oxide nanotube arrays.

Perovskite-type oxides (ABO₃) have a wide application in environmental catalysis, photocatalysis, magnetic devices, chemical sensing, and energy storage and conversion due to their low cost, good catalytic activity and high thermal stability. LaₓSr₁₋ₓCoO₃ as a member of perovskite family shows high catalytic activity for the oxidation of CO and hydrocarbon, NOₓ decomposition, hydrogenation, hydrogenolysis, and high-temperature chemical sensors. Under such reducing atmosphere as H₂, CO, NO and hydrocarbon, LaₓSr₁₋ₓCoO₃ must have good thermal stability in order to satisfy industrial applications while keeping its highly catalytic activity. However, few studies focus on its thermal stability under reducing atmosphere except Nakamura's papers. See T. Nakamura, M. Misono and Y. Yoneda, J. Catal., 1983, 83, 151-159; T. Nakamura, M. Misono and Y. Yoneda, Bull. Chem. Soc. Jpn., 1982, 55, 394-399; T. Nakamura, M. Misono and Y. Yoneda, Chem. Lett., 1981, 10, 1589-1592. They found that the reducibility of LaₓSr₁₋ₓCoO₃ remarkably increased with Sr²⁺ content, while the rate of re-oxidation of the reduced catalysts decreased with x. The oxygen vacancies in the bulk and on the surface also tended to increase with x.

ZnO nanorod arrays (NRAs) have highly specific surface area and can be used as a base for the growth of metal oxide composite NRAs which are expected to have a highly catalytic activity or sensing performance. Jian synthesized La_{0.8}Sr_{0.2}CoO₃ (LSCO)-coated ZnO NRAs and found that they exhibit excellent photocatalytic performance for the degradation of methyl orange. See D. Jian, P.-X. Gao, W. Cai, B. S. Allimi, S. Pamir Alpay, Y. Ding, Z. L. Wang and C. Brooks, J. Mater. Chem., 2009, 19, 970-975. Gao fabricated LSCO-ZnO nanofilm-nanorod diode arrays which display an excellent rectifying I-V characteristic under ±1 V bias with negligible leakage current upon reverse bias. The diode arrays are promising for photo-responsive moisture and humidity detectors. See H. Gao, W. Cai, P. Shimpi, H.-J. Lin and P.-X. Gao, J. Phys. D: Appl. Phys., 2010, 43, 272002. Most recently, it was found, as described above, that the ZnO cores in CeO₂—ZnO and LSCO-ZnO composite NRAs can be removed under reducing atmosphere by a temperature programmed reduction (TPR) process, which eventually leads to the formation of CeO₂ and LSCO nanotube arrays (NTAs). This leads one to consider the thermal stability of ZnO-LSCO composite NRAs under reducing atmosphere due to their wide applications in catalysis, sensing, energy and environment.

In this example, ZnO NRAs were synthesized as a template by a hydrothermal method, and LSCO film was coated onto the template by RF magnetron sputtering to form LSCO-ZnO composite NRAs. Then, the thermal stability was investigated, such as the change in structures and compositions of the LSCO-ZnO composite NRAs by finely adjusting temperature and duration in TPR processes. The strong interaction between ZnO cores and LSCO shells was found to influence the thermal stability under reducing atmosphere. The formation kinetics of LSCO NTAs in the TPR process was also studied in detail.

### Results and Discussion

Thermal Stability of LSCO Films under Reducing Atmosphere

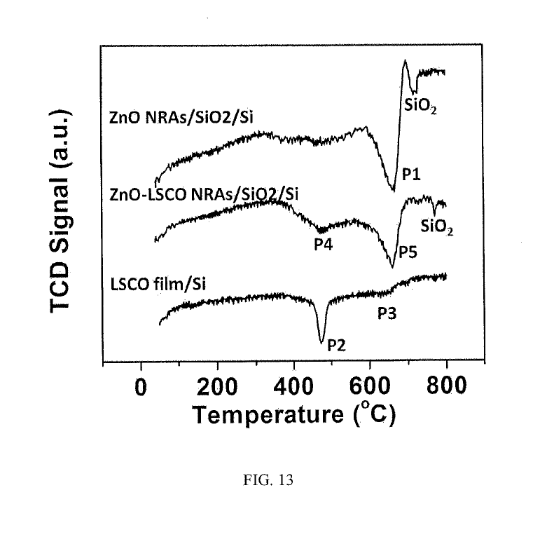

FIG. 13 shows the TPR behaviors of ZnO NRAs, sputtered LSCO films and LSCO-ZnO composite NRAs on Si substrates. For the ZnO NRAs, a TPR peak (P1) appears in the range of 580-700° C. with its maximum at 663° C., which results from the reduction of ZnO by H₂ as stated above (Eq. 1). The small peak at about 725° C. results from the reduction of SiO₂ on the thermally oxidized Si substrate.

For the sputtered LSCO film, there exists a reduction peak (P2) in the range of 350-550° C. with its maximum at 470° C. This is attributed to the reduction of lattice oxygen in LSCO crystal. With increasing TPR temperature, a small reduction peak (P3) with its maximum at 650° C. appears between 550° C. and 720° C. This small peak is due to the collapse of perovskite structure and the formation of a new phase under reducing atmosphere. The attribution of both peaks will be confirmed by the following XRD results. Peak 2 is much higher than Peak 3, which means that the predominant reduction results from the loss of lattice oxygen in perovskite and the collapse of perovskite structure is far less. Fierro et al. studied the reducibility of LaMnO₃ powder in 300 mmHg H₂ atmosphere using weight loss as a TPR signal and found that the reduction process starts at 755 K. See J. L. G. Fierro, J. M. D. Tascón and L. G. Tejuca, J. Catal., 1984, 89, 209-216. Arakawa et al, investigated the reduction of LnCoO₃ (Ln=La—Eu) under hydrogen atmosphere of 2×10⁶ Pa by in-situ XRD and thermogravimetric analysis and found that the weight change of LaCoO₃ due to the loss of lattice oxygen in the reduction process commenced at about 300° C. See T. Arakawa, N. Ohara and J. Shiokawa, J. Mater. Sci., 1986, 21, 1824-1827. The difference in onset reduction temperature between the results presented herein and the earlier results indicates that thermal stability of perovskites (ABO₃) under reducing atmosphere is affected by the cations at A sites and B sites. Moreover, the stability is also affected by different preparation methods for perovskites.

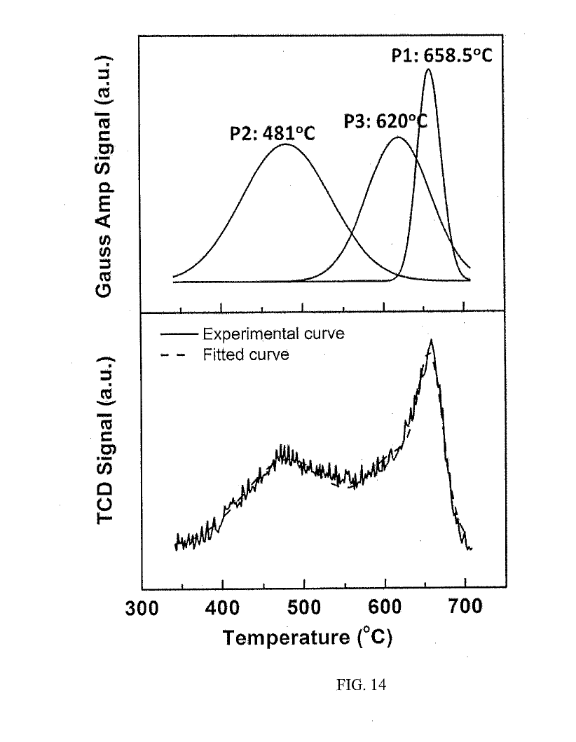

By comparison with the TPR behaviors of ZnO NRAs and LSCO films, the attribution of TPR peaks for LSCO-ZnO composite NRAs was found as: the first peak (P4) in the range of 350-550° C. with its maximum at 475° C. should be mainly attributed to the removal of lattice oxygen in LSCO; the second peak (P5) in the range of 550-720° C. with its maximum at 660° C. is mainly due to the overlapping of ZnO reduction and LSCO decomposition; the third small peak at ca. 770° C. results from the reduction of SiO₂ on the thermally oxidized substrate. However, it can be observed clearly that P4 is partly overlapped with P5. In order to differentiate the contributions from the removal of lattice oxygen in LSCO, LSCO decomposition and ZnO reduction, TPR peaks P4 and P5 were deconvoluted with three peaks by AutoFit Peaks III Deconvolution in PeakFit software, which is shown in FIG. 14. The fitted curve corresponds well to the experimental curve. Compared with the location (663° C.) of P1 on bare ZnO NRAs, P1 on the LSCO-ZnO composite NRAs locates at 658.5° C., which means that the addition of LSCO leads to the decrease of the thermal stability of ZnO NRAs under reducing atmosphere. P2 resulting from the reduction of lattice oxygen in LSCO locates at 481° C. which is 11° C. higher than that (470° C.) on bare LSCO film. P3 due to the collapse of perovskite structure locates at 620° C. which is lower than that (650° C.) on bare LSCO film. This indicates that the addition of ZnO suppresses the release of lattice oxygen in LSCO at low temperature and accelerates the decomposition of LSCO structure at high temperature. The mechanistic exploration about the chemical stability of LSCO-ZnO will be carried out in the XPS section below.

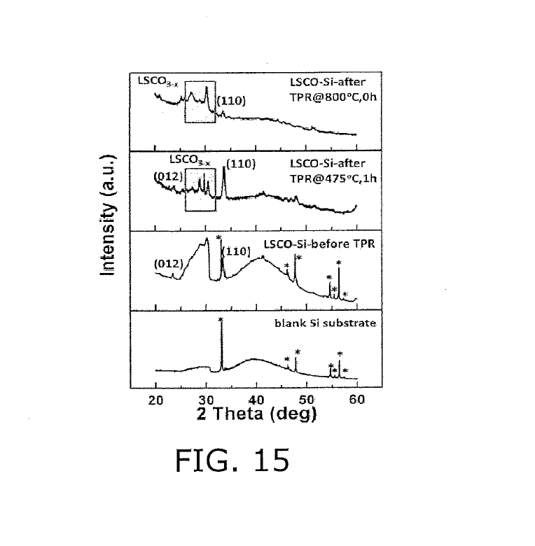

In order to identify the attribution of TPR peaks for the LSCO film in FIG. 13, the XRD patterns of the sputtered LSCO film were investigated before and after TPR processes at 475° C. for 1 hour and 800° C. for 0 hours. As used herein, 0 hours or “without duration” means that the temperature of the sample was raised to the indicated temperature and then immediately lowered back down. As shown in FIG. 15, there are some very small diffraction peaks at 33.0°, 46.2°, 47.8°, 54.7°, 55.5°, 56.4° and 57.4° from the single crystal Si(100) substrate despite of much higher diffraction peak at 68.9° due to the (400) plane which is not shown here because the characteristic peaks from LSCO and ZnO will be covered with this much higher Si(400) peak. The LSCO film before TPR exhibits such characteristic diffraction peaks as (012) and (110), and has Rhombohedral structure (JCPDS #04-013-1000). After TPR at 475° C. for 1 hour, there are some obvious peaks in the range of 27-32° besides the (012) and (110) peaks. These peaks are attributed to La_{0.8}Sr_{0.2}CoO₃₋ₓ (LSCO₃₋ₓ) with an orthorhombic structure (JCPDS #00-046-0704). As generally known in the art, when Sr²⁺ is introduced to the La-sites of LaCoO₃, an abnormal Co⁴⁺ is produced for electro-negativity. Because Co⁴⁺ is unstable and the lattice oxygen has a high chemical potential under reducing atmosphere, Co⁴⁺ tends to be reduced to Co³⁺ by releasing lattice oxygen from bulk to surface (see Eq. 2 above), The reduction process just corresponds to the TPR peak P2 for the LSCO film in FIG. 13.

The release of lattice oxygen during TPR leads to the formation of oxygen vacancies in perovskite lattice, which gives rise to the transition in crystal symmetry of the sputtered LSCO film from Rhombohedral LSCO to Orthorhombic LSCO₃₋ₓ. As mentioned above, the structure is a mixture of Rhombohedral LSCO and Orthorhombic LSCO₃₋ₓ after TPR at 475° C. for 1 hour. When TPR temperature is further increased to 800° C. without duration, (012) peak disappears, (110) peak decreases greatly and the peaks from LSCO₃₋ₓ become more obvious. This means that the release of more lattice oxygen leads to predominantly Orthorhombic LSCO₃₋ₓ. When holding TPR temperature at 800° C. for 2 hours, the crystal symmetry completely becomes Orthorhombic LSCO₃₋ₓ, which will be displayed in the following XRD analysis for the LSCO-ZnO composite NRAs. The conversion of crystal symmetry from Rhombohedral LSCO and Orthorhombic LSCO₃₋ₓ results from the release of lattice oxygen and the production of oxygen vacancies under reducing atmosphere. This change of crystal symmetry induced by lattice oxygen was also reported on LnCoO₃ (Ln=La—Eu) by Arakawa. See T. Arakawa, N. Ohara and J. Shiokawa, J. Mater. Sci., 1986, 21, 1824-1827. Arakawa et al. found that after an isothermal reduction, the crystal symmetry of LaCoO₃₋ₓ changes from Rhombohedral (x=0) to Cubic (I) (x=0.2) and to Cubic (II) (x=0.9) and Orthorhombic (x=0.9), while NbCoO₃₋ₓ changes from Cubic (x=0) to Tetragonal (x=0.5) and to Cubic (x=1.1) and Orthorhombic (x=1.1). The crystal symmetry of SmCoO₃₋ₓ and EuCoO₃₋ₓ changes from Orthorhombic (x=0) to Cubic (x=1.3).

Thermal Stability of LSCO-ZnO Composite NRAs under Reducing Atmosphere and Formation Kinetics of LSCO NTAs

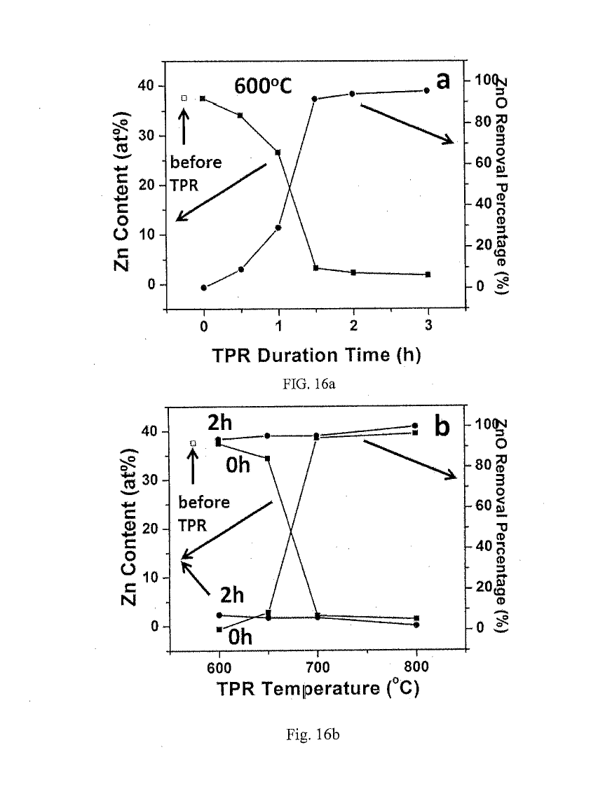

As described above, LSCO-ZnO composite NRAs become LSCO NTAs after TPR at 800° C. for 2 hours. In order to investigate the formation kinetics of LSCO NTAs during TPR, the TPR processes were carried out at different temperature (600° C., 650° C., 700° C. and 800° C.) for various time durations (0 hours, 0.5 hours, 1 hour, 2 hours and 3 hours) and the Zn atomic percentage in the products was checked by Energy-dispersive X-ray spectroscopy (EDX). FIG. 16a shows Zn atomic percentage in the LSCO-ZnO composite NRAs after the TPR process at 600° C. for different time durations. After a TPR process ramping from room temperature to 600° C. without duration, the sample has a Zn atomic percentage of 37.42 at % which is close to that (37.57 at %) before TPR. This indicates that little ZnO was removed during this process. With increasing the TPR time at 600° C., the Zn content decreases gradually. As seen from the cross-sectional SEM images shown in FIGS. 4a and 4b, the NRAs keep the same morphology and length (3.2 μm) after TPR (see FIG. 4b) as before TPR (see FIG. 4a). However, there is an abrupt change from 1 hour to 1.5 hours. The Zn contents are 26.60 at % at 1 hour and 3.22 at % at 1.5 hours, respectively. The ZnO removal percentage increases from 29% to 91%. As such, the length of the NRAs is shortened to be 2.1 μm after TPR from 1 hour to 1.5 hours (see FIG. 4c). After TPR at 600° C. for 3 hours, there is just 3.22 at % Zn left in the product, while the ZnO removal percentage arrives at 95%. The length of the NRAs does not change any more and maintains at 2.1 μm (see FIG. 4d). Therefore, the removal process of ZnO cores can be divided into three stages which are similar to metal corrosion. In the first stage from 0 hours to 1 hour, H₂ is adsorbed on the NRAs surface (Eq. 4). This adsorption step is a slow reaction which is the rate determining step. The adsorbed hydrogen probably reacts slowly with ZnO on the defects. In the second stage from 1 hour to 1.5 hours, the ZnO cores are reduced and removed rapidly after the initiation step (Eq. 5). In the third stage, a small quantity of residual ZnO is finally removed.

H₂(g)→2H_{ad} (4)

2H_{ad}+ZnO(s)→Zn(g)+H₂O(g) (5)

FIG. 16b shows the Zn atomic percentage in the LSCO-ZnO composite NRAs after TPR at different temperatures for 0 hours and 2 hours. In the case of TPR at the specific temperature without duration, there exists an abrupt decrease in the Zn content from 650° C. to 700° C. The ZnO removal percentage increases from 9% to 94%. In the case of TPR at all applied temperatures for 2 hours, the Zn content is less than 3 at %, while the ZnO removal percentage is above 93%. When a TPR process at 800° C. for 2 hours is applied, there is no Zn signal in the product and the ZnO removal percentage arrives at 100%. The pure LSCO NTAs are formed on Si. Therefore, TPR temperature and time have a great effect on the removal of ZnO template and play an important role in the formation of pure LSCO NTAs.

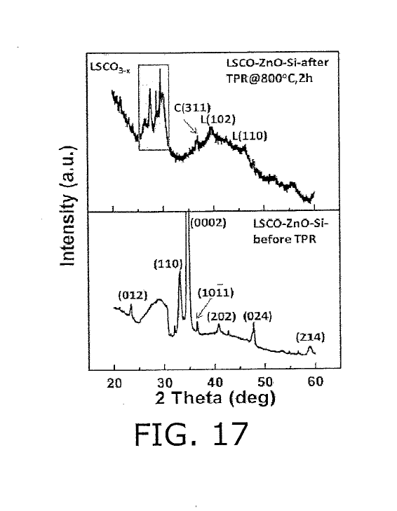

FIG. 17 shows the XRD patterns of LSCO-ZnO composite NRAs before and after TPR at 800° C. for 2 hours. Before TPR, there exist the peaks both from perovskite-type LSCO [(012), (110), (202), (024) and (214), JCPDS #04-013-1000] and from hexagonal wurtzite ZnO [(0002) and (10 1̅1), JCPDS #36-1451]. After TPR at 800° C. for 2 hours, the diffraction peaks from ZnO and LSCO disappear, while the peaks from LSCO₃₋ₓ appear. This indicates that the ZnO have been removed, while the crystal symmetry of LSCO completely becomes Orthorhombic LSCO₃₋ₓ. Moreover, some very weak peaks from La₂O₃ [L(102) and L(110), JCPDS #05-0602] and Co₃O₄ [C(311), JCPDS #43-1003] appear in the XRD patterns. This indicates that the slight decomposition of LSCO occurs at high temperature under reducing atmosphere as shown in Eq. 6. Fierro et al. also found the disappearance of LaMnO₃ perovskite structure with the formation of the isolated La₂O₃ and MnO phases. See J. L. G. Fierro, J. M. D. Tascón and L. G. Tejuca, J. Catal., 1984, 89, 209-216.

$${La}_{1 - x}^{3 +} {Sr}_{x}^{2 +} + {Co}_{1 - x}^{3 +} {Co}_{x}^{4 +} {O}_{3} + \frac{1 + 3 x}{6} {H}_{2} \to \frac{1 - x}{2} {La}_{2} {O}_{3} + xSrO + \frac{1}{3} {Co}_{3} {O}_{4} + \frac{1 + 3 x}{6} {H}_{2} O \qquad ( 6 )$$

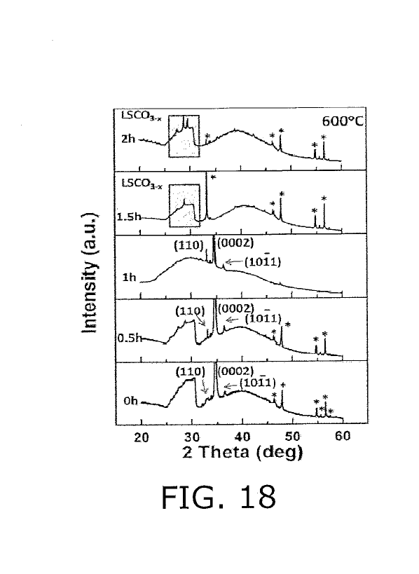

FIG. 18 shows the XRD patterns of LSCO-ZnO composite NRAs after TPR at 600° C. for different time durations. After TPR at 600° C. for 0 hours, 0.5 hours and 1 hour, the diffraction peaks both from ZnO [(0002) and (1011)] and from LSCO [(110)] are still present. However, after TPR for 1.5 hours, the peaks from ZnO disappear and the peaks from LSCO₃₋ₓ appear. This is consistent with EDX (see FIG. 17) and cross-sectional SEM results. Moreover, after TPR for 2 hours, the peaks from LSCO₃₋ₓ become stronger. This means that with the extension of TPR time, more and more lattice oxygen is removed from the perovskite-type LSCO crystal lattice.

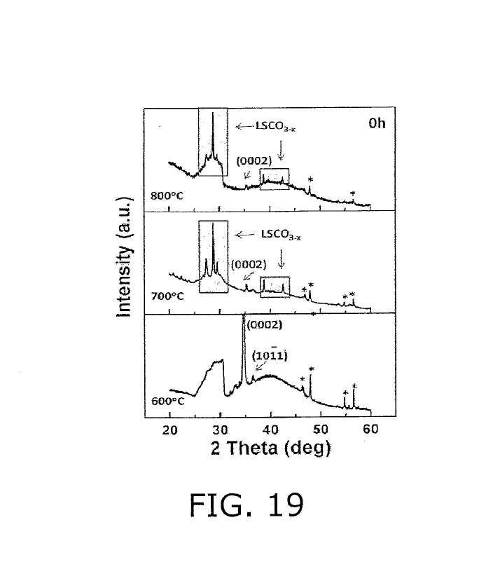

FIG. 19 shows the XRD patterns of LSCO-ZnO composite NRAs after TPR at different temperatures for 2 hours. After TPR at all temperatures for 2 hours, the diffraction peaks both from ZnO and from LSCO disappear. Meanwhile, the peaks from LSCO₃₋ₓ appear in all cases.

In view of EDX and XRD analysis, it was found that it was possible to control the amount of lattice oxygen in the LSCO crystal lattice and thus to optimize its catalytic performance by finely adjusting temperature and duration in the TPR process. As is generally known, lattice oxygen (or oxygen vacancies) in perovskite has a great effect on catalytic performance. For example, NO can transfer the O atom to the O vacancies in perovskite catalysts and thus be reduced to N₂. The number of O vacancies on the surface is important for the rate of NO conversion. The catalytic mechanism of CO oxidation over La_{0.5}Sr_{0.5}MnO₃ cubes was proposed that the adsorbed CO was oxidized by lattice oxygen. Then the chemisorbed oxygen over La_{0.5}Sr_{0.5}MnO₃ cubes was transformed into the lattice oxygen by MnO₆ octahedron to reinforce the consumed lattice oxygen.

Strong Interaction between ZnO Cores and LSCO Shells and its Effects on the Thermal Stability of ZnO and LSCO under Reducing Atmosphere

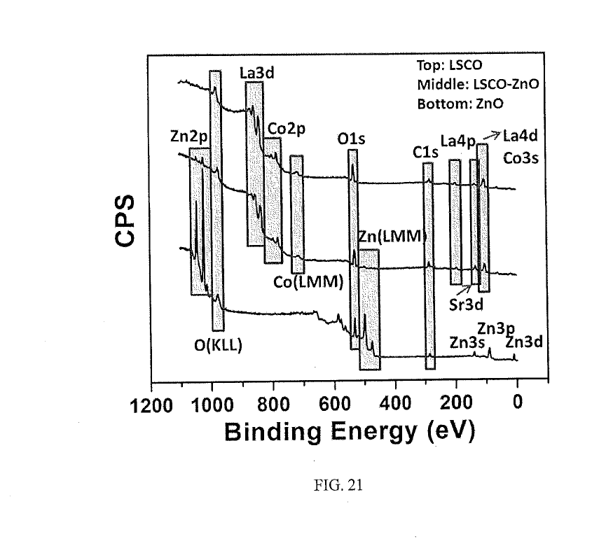

FIG. 21 shows the XPS survey spectra of ZnO NRAs, LSCO-ZnO composite NRAs and LSCO NTAs on thermally oxidized Si substrates. For ZnO NRAs, there exist the signals from Zn [Zn(2p), Zn(3s), Zn(3p), Zn(3d) and Zn(LMM)] and O [O(1s) and O(KLL)]. After being coated with an LSCO film, LSCO-ZnO composite NRAs exhibit the signals from La [La(3d), La(4p) and La(4d)], Co [Co(2p), Co(3s) and Co(LMM)] and Sr [Sr(3d)] besides those from Zn and O. After TPR at 800° C. for 2 hours, the signals from Zn disappear and only those from La, Co and Sr are left. This further confirms that the ZnO template, even on the surface, has been removed completely after TPR and the product is pure LSCO NTAs.

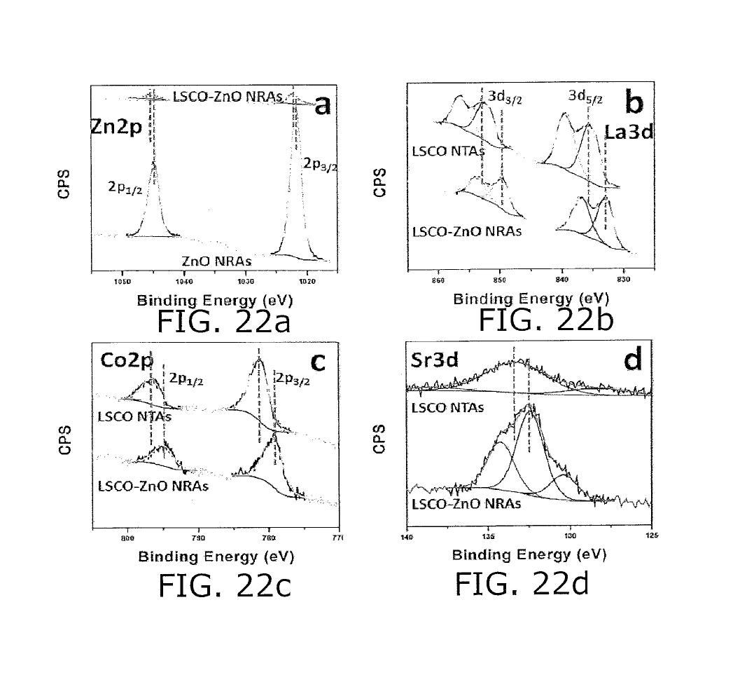

The creation of LSCO NTAs by TPR provides an opportunity for decoupling the functions and contributions of cores and shells in composite NRAs, which makes it possible to study the interaction between cores and shells. FIG. 22 shows the XPS fine spectra of ZnO NRAs, LSCO-ZnO composite NRAs and LSCO NTAs on thermally oxidized Si substrates. As shown in FIG. 22a, Zn(2p) peaks for LSCO-ZnO composite NRAs shift by 0.4 eV towards higher binding energy those ZnO NRAs. This indicates that the electron cloud density around Zn nuclei shifts away from Zn nuclei after the modification of LSCO. Meanwhile, La(3d), Co(2p) and Sr(3d) peaks for LSCO-ZnO composite NRAs shift by 2.5 eV, 1.7 eV and 0.9 eV towards lower binding energy than those for LSCO NTAs, respectively (see FIGS. 22b, 22c and 22d). This indicates that the electron cloud density around La, Co and Sr nuclei increase in the presence of ZnO. Obviously, there exists strong interaction in the interface between ZnO cores and LSCO shells in the composite NRAs. Undoubtedly, this strong interaction will have a great effect on catalytic activity and stability of the composite NRAs.

XPS results are further correlated with the chemical stability of LSCO-ZnO composite NRAs as shown in FIGS. 13 and 14. First, in the LSCO-ZnO composite NRAs, the modification of LSCO leads to the positive shifting of Zn(2p). That is, the electron cloud density around Zn nuclei in ZnO decreases. As shown in Eq. 1, ZnO is an oxidant in such a redox reaction. Therefore, the deficiency of electrons in ZnO will lead to easier reduction of ZnO by H₂. This deduction is consistent with the TPR experimental result that LSCO leads to the decrease of the thermal stability of ZnO NRAs under reducing atmosphere. Second, in the LSCO-ZnO composite NRAs, the modification of ZnO leads to the negative shifting of Co(2p). That is, the electron cloud density around Co nuclei in LSCO increases, which will decrease the proportion of Co⁴⁺ in LSCO. As shown in Eq. 2, the release of lattice oxygen in LSCO results from the reduction of Co⁴⁺ to Co³⁺. Therefore, the addition of ZnO suppresses the release of lattice oxygen in LSCO and increases its thermal stability at low temperature. As shown in Eq. 6, LSCO (or LSCO₃₋ₓ) is decomposed to mixed oxides at high temperature under reducing atmosphere. LSCO is easier to decompose than LSCO₃₋ₓ because it has more lattice oxygen to form mixed oxides. In the presence of ZnO, more LSCO survives in the TPR process at low temperature because the addition of ZnO suppresses the release of lattice oxygen in LSCO as stated above. Therefore, the addition of ZnO accelerates the decomposition of LSCO at high temperature, which is consistent with TPR results.

### Conclusions

ZnO NRAs and LSCO-ZnO composite NRAs have been prepared on Si substrates by a hydrothermal method and a magnetron sputtering method, respectively. The TPR technique has been employed to investigate their thermal stability under reducing atmosphere. TPR and XRD results indicate that LSCO exhibits high chemical stability and is found to just lose lattice oxygen and produce oxygen vacancies, which leads to the transition of crystal symmetry from Rhombohedral LSCO to Orthorhombic LSCO₃₋ₓ. EDX, XRD and XPS survey spectra show that ZnO cores are removed gradually in this TPR process, which leads to the formation of LSCO NTAs. Further XPS fine analysis implies that there exists strong interaction between ZnO cores and LSCO shells in the composite NRAs. Under reducing atmosphere, this interaction decreases the thermal stability of ZnO NRAs, suppresses the release of lattice oxygen in LSCO at low temperature, and accelerates the decomposition of LSCO structure at high temperature.

### Experimental Section

### Preparation of ZnO NRAs Template

ZnO NRAs template was grown on a thermally oxidized Si(100) substrate by a hydrothermal method as described above. Prior to growth, a ZnO seed layer of 30 nm was deposited onto the substrate by a RF magnetron sputter (Torr International, Inc.) using a ZnO target (99.9% pure, Kurt J. Lesker Company) and then annealed at 600° C. for 2 hours. ZnO NRAs were further grown on the Si substrate with a ZnO seed layer with a hydrothermal method. The Si substrate with a ZnO seed layer was immersed into the solution of 0.02 mol L⁻¹ zinc acetate (ZnAc₂) and 0.02 mol L⁻¹ hexamethylenetetramine (HMT) in a container. Subsequently, the container was sealed and put into a water bath. The growth was carried out at 90° C. for 5 hours. Finally, the sample was cleaned several times with DI water and dried at 80° C. overnight as the template.

### Preparation of LSCO Film and LSCO-ZnO Composite NRAs on Si Substrates

LSCO nanofilm was deposited on the ZnO NRAs template by a RF magnetron sputter using a LSCO target (La_{0.8}Sr_{0.2}CoO₃, Kurt J. Lesker Company) in 7.38×10⁻³ Torr of Argon plasma. The thickness (100 nm) in the RF sputter panel was used as the reference thickness of the sputtered nanofilms on ZnO NRAs. After sputtering, the sample was annealed at 800° C. for 3 hours. For comparison, a LSCO film with 100 nm of thickness was also sputtered on a Si substrate by the same procedure.

Thermal Stability of LSCO Film and LSCO-ZnO Composite NRAs under Reducing Atmosphere

The thermal stability of LSCO film and LSCO-ZnO composite NRAs were investigated by a TPR method (ChemSorb 2720 Pulse Chemisorption System, Micromeritics Instrument Corporation) under hydrogen atmosphere. First, the sample is dried at 150° C. under N₂ with a flow rate of 25 sccm. Then 10 vol % H₂ in N₂ with a flow rate of 25 sccm was fed through the TPR sample cell. In a typical case, the temperature changed from room temperature to 800° C. with a ramping rate of 10° C. min⁻¹ and was held for 2 hours. After cooling down under N₂ atmosphere to room temperature, the samples were obtained. In order to investigate the formation kinetics of LSCO NTAs, various TPR temperatures (600° C., 650° C., 700° C. and 800° C.) and time durations (0 hours, 0.5 hours, 1 hour, 1.5 hours and 2 hours) were employed.

### Physiochemical Characterizations

Morphology, crystallography and elemental compositions were determined with a field emission scanning electron microscope (JEOL 6335 FESEM 016) and Tecnai T-12 transmission electron microscope. X-ray diffraction (XRD) was performed using a Bruker D8 Advance X-ray diffractometer equipped with a Cu Kα (k=1.5405 Å) as radiation source operating at 40 kV and 40 mA. X-ray photoelectron spectroscopy (XPS) was performed with a Scanning Auger Multi Probe PHI Spectrometer (Model 25-120) equipped with Al source operating at 15 kV and 20 mA. The signal was filtered with a hemispherical analyzer (pass energy=100 eV for survey spectra and 25 eV for fine spectra). The C(1s) photoelectron line at 284.6 eV was used as an internal standard for the correction of the charging effect in all samples.

### Example 2

### Decouple the Photo-Catalytic Functions of Metal Oxide Core and Shell in Composite Nanorod Arrays

Heterostructured nanomaterials have been demonstrated with a great deal of success in achieving novel and enhanced functionality during the past few decades. However, the understanding of roles in the interfaces and dissimilar materials components is lacking in the nanoscale heterostructure systems. Here, using heterostructured ZnO based nanorod arrays as a model system, and photo-catalytic degradation of organic dyes such as Rhodamine B (RB) as the probe function, the roles played in the individual ZnO core and metal oxide shell components are decoupled, and reveal and identify the interactions necessary in terms of band structure alignment for improved catalytic performance in the heterostructured nanorod arrays. Based on the hydrothermally deposited ZnO nanorod arrays (NRAs) on Si substrates, binary metal oxides such as CeO₂ and SnO₂, and ternary systems such as La_{0.8}Sr_{0.2}CoO₃ (LSCO) have been prepared as the shell component using magnetron sputtering. In order to decouple the photo-catalytic functions and contributions of the cores and shells in the composite NRAs, CeO₂, LSCO, and SnO₂ nanotube arrays (NTAs) have been fabricated by temperature programmed reduction method and wet etching method, respectively. By comparing the photo-degradation of RB on these materials, it was found that the SnO₂ nanoshell displays the highest enhancement, with CeO₂-nanoshell the second, while ternary LSCO nanoshells show the smallest enhancement. Strong electronic interactions between ZnO cores and SnO₂ shells, and between ZnO cores and LSCO shells have been revealed in the X-ray photoelectron spectroscopy (XPS), while no clear interaction was revealed between ZnO cores and CeO₂ shells. This can be correlated well with the electron energy band structures in ZnO, CeO₂, SnO₂ and LSCO. It is suggested that Type II alignment systems such as SnO₂—ZnO are favorable for the photo-catalysis, while Type I alignment systems such as LSCO-ZnO increase the recombination probability and thus reduce the photo-catalytic performance.

A controllable method to prepare metal or metal oxide nanotube arrays (NTAs) was described above: temperature programmed reduction (TPR) using ZnO NRAs as a template. ZnO NRAs template prepared by a hydrothermal method was coated with CeO₂ and La_{0.8}Sr_{0.2}CoO₃ (LSCO) films by RF magnetron sputtering or colloidal deposition on planar and 3D monolith honeycomb substrates. Then CeO₂ and LSCO NTAs were obtained by sacrificing the ZnO template under reductive atmosphere with the TPR method. The as-prepared nanotube arrays kept a highly integral structure and valid composition after the removal of ZnO NRAs, which makes it possible to decouple the contributions and functions of cores and shells in the composite NRAs for the application in catalysis, sensing, energy and environment.

In this exemplary embodiment, ZnO NRAs were synthesized as a template by a hydrothermal method. Then the CeO₂—ZnO, SnO₂—ZnO and LSCO-ZnO composite NRAs were prepared by coating the corresponding oxide thin films through a RF magnetron sputtering method. Finally, CeO₂, SnO₂ and LSCO NTAs with integral structures were obtained by a TPR method and a wet etching method, respectively. Rhodamine B (RB) was chosen as a representative of organic pollutants to evaluate their photo-catalytic activities. By comparing the photo-catalytic degradation of RB on these materials, the contributions of cores and shells in the composite NRAs were decoupled and the effect of different shells on the photo-catalytic performance of the composite NRAs was investigated.

### Experimental Section

### Preparation of ZnO NRAs Template

The ZnO NRAs template was grown on thermally oxidized Si(100) substrate using the method described above, with the modifications described below. Prior to growth, a ZnO seed layer of 30 nm was deposited onto the substrate by a RF magnetron sputter (Ton International, Inc.) using a ZnO target (99.9% pure, Kurt J. Lesker Company) and then annealed at 800° C. for 3 hours. ZnO NRAs were further grown on the Si substrate with a ZnO seed layer with a hydrothermal method. The Si substrate with a ZnO seed layer was immersed into the solution of 0.02 mol L⁻¹ zinc acetate (ZnAc₂) and 0.02 mol L⁻¹ hexamethylenetetramine (HMT) in a container. Subse-quently, the container was sealed and put into a water bath. The growth was carried out at 90° C. for S hours. Finally, the sample was cleaned several times with DI water and dried at 80° C. overnight as the template.

### Preparation of CeO₂—ZnO, SnO₂—ZnO and LSCO-ZnO Composite NRAs

CeO₂, SnO₂ and LSCO nanofilms were deposited on the ZnO NRAs template by a RF magnetron sputter using a CeO₂ target (99.99% pure, Kurt J. Lesker Company), SnO₂ target (99.99% pure, Kurt J. Lesker Company) and LSCO target (La_{0.8}Sr_{0.2}CoO₃, Kurt J. Lesker Company) in 7.36×10⁻³ Torr of Argon plasma, respectively. The thickness (100 nm) in the RF sputter panel was used as the reference thickness of the sputtered nanofilms on ZnO NRAs.

### Formation of CeO₂, SnO₂ and LSCO NTAs

CeO₂ NTAs and LSCO NTAs were obtained by a TPR method (ChemSorb 2720 Pulse Chemisorption System, Micromeritics Instrument Corporation) under hydrogen atmosphere. First, the CeO₂—ZnO composite NRAs were dried at 150° C. under N₂ with a flow rate of 25 sccm. Then 10 vol % H₂ in N₂ with a flow rate of 25 sccm was fed through the TPR sample cell. The temperature changed from room temperature to 800° C. with a ramping rate of 10° C. min⁻¹. After cooling down under N₂ atmosphere to room temperature, the nanotube arrays on Si substrate were obtained. In the case of LSCO NTAs, the same TPR process was employed except that the TPR temperature was held at 800° C. for 2 hours. After the TPR process, the CeO₂ NTAs and LSCO NTAs were further annealed at 500° C. for 3 hours to improve their crystallinity. The SnO₂ NTAs were obtained by a wet etching process. The SnO₂—ZnO composite NRAs on Si substrate were placed into a petri dish with 0.25 vol % of 37% HCl aqueous solution. A noticeable gradual discoloration from dark blue to light transparent grey would suggest the end of the whole process. It usually lasted from 10 min to 1 hour depending on the situation. After the wet etching, the SnO₂ NTAs were further annealed at 600° C. for 4 hours to improve the crystallinity.

### Physiochemical Characterizations

Morphology, crystallography and elemental compositions were determined with a field emission scanning electron microscope (JEOL 6335 FESEM 016) and Tecnai T-12 transmission electron microscope. X-ray diffraction (XRD) was performed using a Bruker D8 Advance X-ray diffractometer equipped with a Cu Kα (k=1.5405 Å) as radiation source operating at 40 kV and 40 mA. The Brunauer-Emmett-Teller (BET) surface area was determined using Micromeritics ASAP 2020 Automatic Chemisorption Analyzer. X-ray photoelectron spectroscopy (XPS) was performed with a Scanning Auger Multi Probe PHI Spectrometer (Model 25-120) equipped with Al source operating at 15 kV and 20 mA. The signal was filtered with a hemispherical analyzer (pass energy=100 eV for survey spectra and 25 eV for fine spectra). The C(1s) photoelectron line at 284.6 eV was used as an internal standard for the correction of the charging effect in all samples.

### Photo-Catalytic Tests

In order to investigate the photo-catalytic efficiency of these materials, 0.001 mg ml⁻¹ of RB aqueous solution was used as a probe. Prior to irradiation, the Si substrates coated with the catalysts were immersed into the above solution and placed in darkness for 30 minutes to establish an adsorption/desorption equilibrium. The solution containing the substrate was subsequently irradiated using a Luzchem ring illuminator with UV light (310-400 nm, peak at 356 nm, 22 W). The concentrations of RB in the supernatant were monitored and analyzed by measuring the absorbance at 557 nm wavelength using a Perkin Elmer Lambda 900 UV/VIS/near IR Spectrometer.

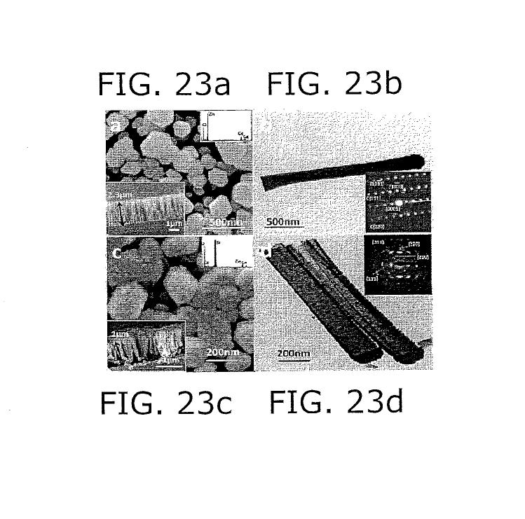

FIG. 23 shows the morphology and composition of the CeO₂—ZnO composite NRAs and CeO₂ NTAs on thermally oxidized Si substrates. Initially, the as-prepared ZnO template exhibits a densely packed and well-aligned array, and has a diameter ranging from 100 nm to 150 nm and a length of 2.2 μm. As seen from FIG. 23a, after being coated with CeO₂ layer by magnetron sputtering, the composite CeO₂—ZnO exhibits the same nanorod arrays structure and the same length (about 2.3 μm). The diameter of a nanorod is increased to be in a range from 180 nm to 300 nm, which means that the thickness of the sputtered CeO₂ is in a range from 80 nm to 150 nm. The EDX spectrum in the upper inset of FIG. 23a shows that there exist the signals from Zn, Ce and O which results from the ZnO cores and CeO₂ shells. Compared with the smooth surface of ZnO NRAs template, the composite NRAs have a coarse surface on the top and a diameter of about 200 nm (see FIG. 23b). The selected area electron diffraction (SAED) pattern in the inset of FIG. 23b displays the diffraction spots from ZnO such as (0001), (10 1̅0) and (10 1̅1), and the diffraction rings from CeO₂ such as {111} and {220}, which demonstrates that the ZnO nanorods are single crystallinity and grow along with [0001], while the CeO₂ shells outside ZnO NRAs are polycrystalline. TPR treatment on the composite NRAs was further carried out under a reducing atmosphere. As shown in FIG. 23c, after the TPR process, the product clearly has retained the structural integrity and distribution as the CeO₂—ZnO composite NRAs. The individual rods have nearly the same diameter. However, the length is only about 1 μm. Moreover, it is also found from the EDX spectrum in the upper inset of FIG. 23c that there only exist the signals from Ce and O besides Si. The shortening of arrays and the disappearance of Zn signal imply that the product is CeO₂ nanotube arrays, which is further clearly observed by TEM imaging (see FIG. 23d) with an outer diameter of about 200 nm, an inner diameter of about 110 nm, and a wall thickness of about 90 nm. The SAED pattern in the inset of FIG. 23d reveals the characteristic rings corresponding to {111}, {200}, {220} and {311} atomic planes of CeO₂, which indicates the polycrystalline nature of CeO₂ NTAs with a fluorite cubic structure (JCPDS #43-1002). Unlike the SAED of the CeO₂—ZnO composite NRAs, the single-crystal diffraction spots from ZnO disappeared completely.

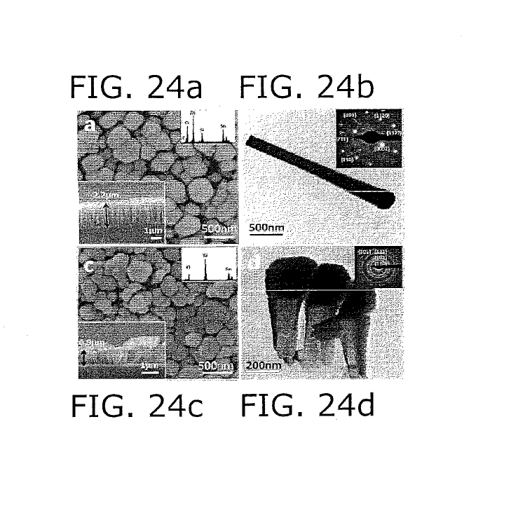

FIG. 24 displays the morphology and composition of the SnO₂—ZnO composite NRAs and SnO₂ NTAs on thermally oxidized Si substrates. Compared to the case of CeO₂, the composite SnO₂—ZnO exhibits the same nanorod arrays structure and the same length of about 2.2 μm. The diameter of a nanorod is increased to be in a range from 190 nm to 330 nm (see FIG. 24a). As shown in FIG. 24b, the composite NRAs exhibit a coarse surface. The SAED pattern reveal the single crystal diffraction spots from ZnO cores and the polycrystalline diffraction rings from SnO₂ such as {110}, {101} and {221}. After the wet etching process, the product has also retained the structural integrity and distribution as the SnO₂—ZnO composite NRAs (see FIG. 24c). The length of arrays is shortened to be about 0.9 μm. Moreover, the EDX spectrum in the upper inset of FIG. 24c only shows the presence of Sn, O and Si signals. Both hollow structure and polycrystalline rings seen from TEM images and SAED pattern in FIG. 24d confirm that the product is SnO₂ nanotube arrays with a polycrystalline shell.

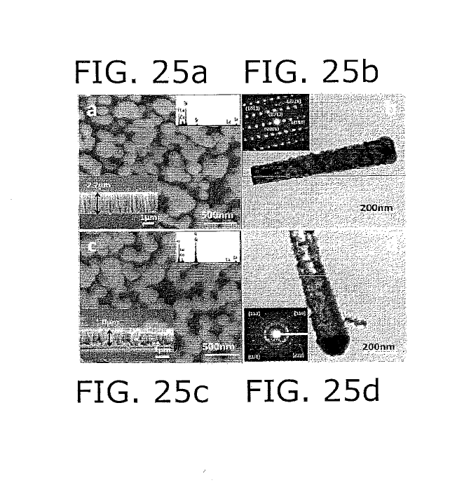

FIG. 25 displays the morphology and composition of the LSCO-ZnO composite NRAs and LSCO NTAs on thermally oxidized Si substrates. The composite LSCO-ZnO NRAs have the same length of about 2.2 μm and the diameter in a range from 170 nm to 310 nm (see FIG. 25a). The TEM image and SAED pattern in FIG. 25b show that the composite NRAs have a single-crystal ZnO core and a polycrystalline LSCO shell. As shown in FIGS. 25c and 25d, after the TPR process, only the polycrystalline shells of LSCO remain The length of LSCO NTAs is also about 1.0 μm.

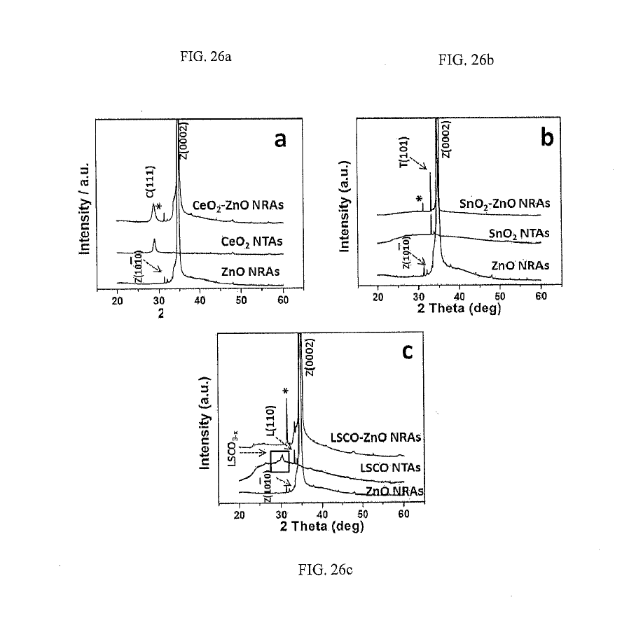

XRD patterns were used to investigate the bulk compositions and crystallinity of samples. FIG. 26 shows the XRD patterns of the ZnO NRAs, CeO₂ series, SnO₂ series and LSCO series catalysts on thermal oxidized Si substrates. As shown in FIG. 26a, the ZnO NRAs prepared by a hydrothermal method have a hexagonal wurtzite structure (space group: P63mc) with a (0002) preferential orientation. After being coated with a CeO₂ film, the characteristic diffraction peak (111) of CeO₂ also appears in the XRD pattern, which is attributed to the fluorite cubic structure of CeO₂ (JCPDS #43-1002). After the TPR process, the diffraction peaks such as (0002) and (10 1̅0) from ZnO disappeared and the diffraction peaks from CeO₂ with a face-centered cubic (fcc) structure are only left. As such, after being coated with a SnO₂ film, the characteristic diffraction peak (101) of SnO2 also appears in the XRD pattern as shown in FIG. 26b, which is attributed to the tetragonal structure of SnO₂ (JCPDS #41-1445). After the wet etching process, the diffraction peaks from ZnO disappear and only the diffraction peaks from SnO₂ are left. As seen from FIG. 26c, after being coated with a LSCO film, the characteristic diffraction peak (110) from LSCO appears in the XRD pattern, which is attributed to rhombohedral structure of La_{0.8}Sr_{0.2}CoO₃ (JCPDS #01-073-5934). After the TPR process, the diffraction peaks from ZnO disappeared and only the diffraction peak from LSCO was left. The peaks in the range of 27-31° result from LSCO₃₋ₓ (JCPDS #46-0704) which is due to the removal of a small amount of lattice oxygen during the reduction process (see FIG. 26c). According to the analysis of FIG. 26, CeO₂ and SnO₂ NTAs are found to have the same crystal structure as in the composite NRAs, while LSCO has a slight change in the crystal structure due to the loss of lattice oxygen during the TPR process despite the post heat treatment at 500° C. for 3 hours in air.

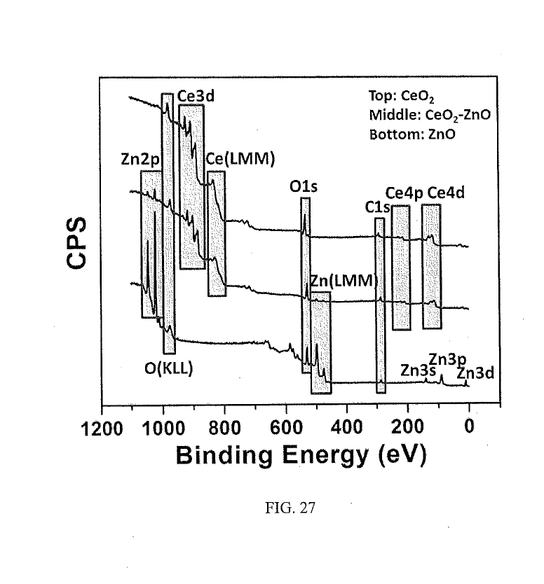

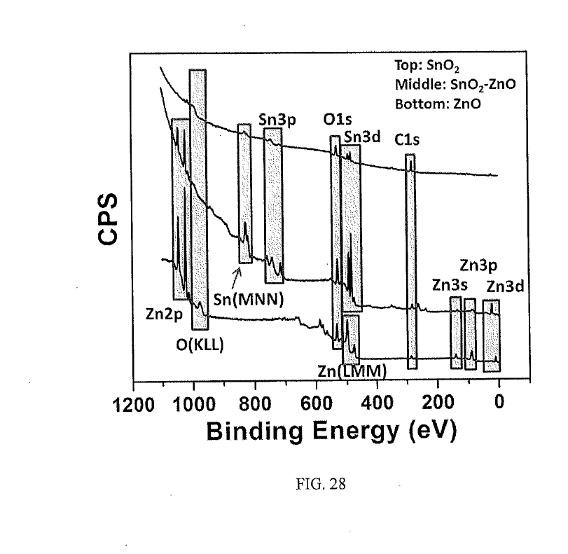

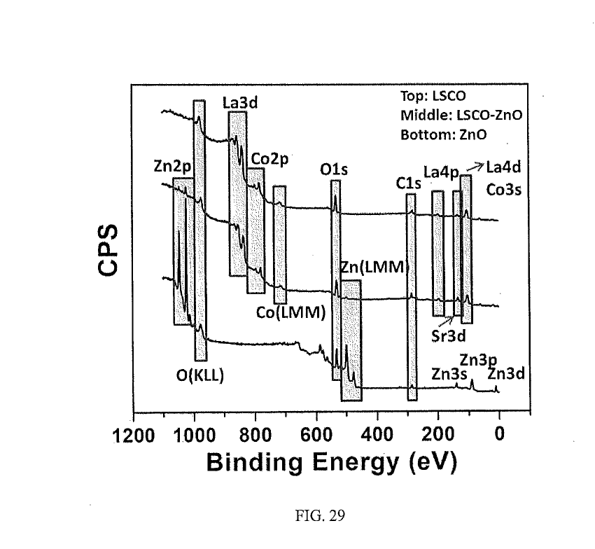

XPS spectra were used to investigate the compositions on the surface of samples. FIG. 27 shows the XPS survey spectra of the ZnO NRAs, CeO₂—ZnO composite NRAs and CeO₂ NTAs on thermal oxidized Si substrates. As seen from the XPS survey spectrum of the ZnO NRAs, there exist the signals from Zn such as Zn(2p), Zn(3s), Zn(3p), Zn(3d) and Zn(LMM) and from O such as O(1s) and O(KLL). After being coated with a CeO₂ film, the CeO₂—ZnO composite NRAs exhibit the signals from Ce such as Ce(3d), Ce(4s), Ce(4p), Ce(4d) and Ce(LMM) besides the signals from Zn and O. The Ce(4s) is not indexed in the survey spectra due to its partly overlapping with C(1s). After the TPR process, the XPS peaks from Zn disappear and only the XPS peaks from Ce are left. This further confirms that the ZnO cores have been removed completely after the TPR process and the product is CeO₂ nanotube arrays. The XPS survey spectra of the SnO₂ series (ZnO NRAs, SnO₂—ZnO composite NRAs and SnO₂ NTAs) are shown in FIG. 28, and the XPS survey spectra of the LSCO series (ZnO NRAs, LSCO-ZnO composite NRAs and LSCO NTAs) are shown in FIG. 29. As shown in FIG. 28, after being coated with a SnO₂ film, the composite SnO₂—ZnO composite NRAs exhibit the signals from Sn such as Sn(3p), Sn(3d) and Sn(MNN) besides those from Zn and O. After the wet etching process, the XPS peaks from Zn disappear and only the XPS peaks from Sn are left. As such, after being coated with a LSCO film, the LSCO-ZnO composite NRAs exhibit the signals from La such as La(3d), La(4p) and La(4d), those from Sr such as Sr(3d) and those from Co and Co(3s) besides those from Zn and O (see FIG. 29). After the TPR process, the XPS peaks from Zn disappear and only the XPS peaks from La, Sr and Co are left. XPS survey further confirm that there is no residual Zn template on the surface of the CeO₂—ZnO, SnO₂—ZnO and LSCO-ZnO composite NRAs and the products after the TPR and wet etching processes are pure CeO₂, SnO₂ and LSCO nanotube arrays.

Through a series of above characterizations, it was confirmed that the ZnO cores in the composite NRAs are removed completely by the TPR or wet etching processes. The as-prepared CeO₂, SnO₂ and LSCO NTAs have very intact shells and valid compositions, which makes it feasible to compare their photo-catalytic performance with the corresponding composite NRAs and ZnO NRAs, and further decouple the contributions of cores and shells in the composite NRAs.

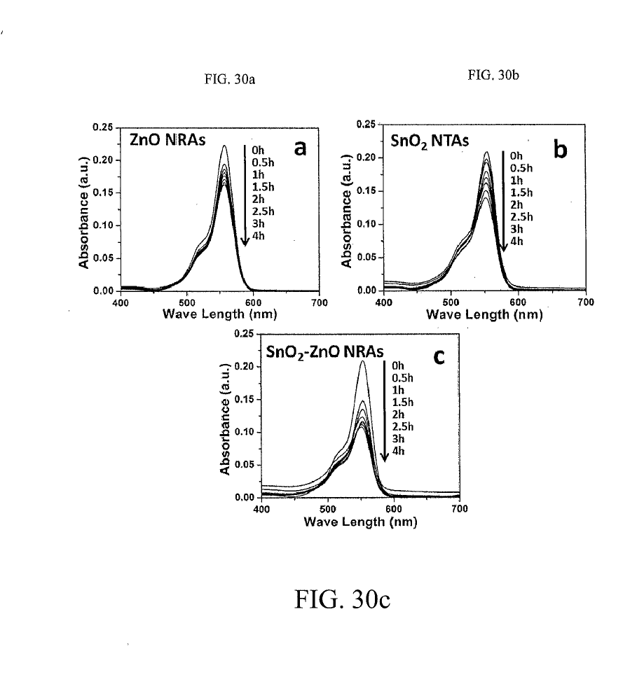

UV-vis absorption spectra were employed to determine RB concentrations after radiation for various time durations. FIG. 30 shows the UV-vis absorption spectra of RB after irradiation for various time durations on the ZnO NRAs, SnO₂—ZnO composite NRAs and SnO₂ NTAs. As shown in FIG. 30a, there exist a main peak at about 557 nm and a shoulder peak at about 525 nm which are due to the photo-absorption of RB. The absorbance of RB decreases with the irradiation time. During the initial 0.5 hours, the rapid decrease of RB absorbance is probably due to the adsorption of a large quantity of RB on the nanorod arrays with a high surface area besides the degradation of RB, which can be concluded from the evidence that the point at 0.5 hours clearly deviates from the fitted line of −ln(C/C₀) vs. t. As such, the similar behaviors of RB degradation occur on the SnO₂ NTAs (FIG. 30b), SnO₂—ZnO composite NRAs (FIG. 30c), CeO₂ NTAs, CeO₂—ZnO composite NRAs, LSCO NTAs, and LSCO-ZnO composite NRAs (the UV-vis spectra of CeO₂ series and LSCO series are not shown here). These results indicate that the ZnO NRAs, CeO₂ series and LSCO series can function as catalysts for the photo-degradation of RB. As one knows, when the UV light (356 nm in this case) with an energy higher than the bandgap energy of semiconductors is illuminated onto the sample, the semiconductor (e.g., ZnO, CeO₂, SnO₂ and LSCO) is excited to produce a hole in the valence band and an electron in the conduction band. The photo-excited holes in the valence band can form the hydroxyl radical (OH.) with water or OH⁻ which leads to the oxidative degradation of dyes. Meanwhile, the electrons in the conduction band participate in a reductive process to form a closed catalytic cycle. Therefore, the photo-catalytic performance of semiconductors depends on their band gap and recombination of electrons and holes.

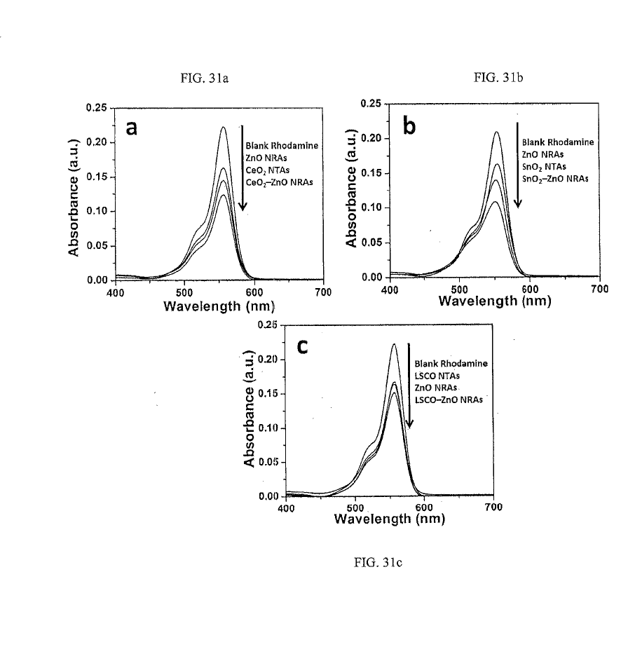

FIG. 31 shows the UV-vis absorption spectra of RB after being irradiated for 4 hours on three series of materials. As seen from FIG. 31a, the absorbance of RB is 0.222 without catalysts, while it is 0.163 for the ZnO NRAs, 0.146 for the CeO₂ NTAs, and 0.124 for the CeO₂—ZnO composite NRAs, respectively. As such, the absorbance of RB is 0.140 for the SnO₂ NTAs, and 0.108 for the SnO₂—ZnO composite NRAs, respectively (see FIG. 31b). The absorbance of RB is 0.167 for the LSCO NTAs, and 0.151 for the LSCO-ZnO composite NRAs, respectively (see FIG. 31c). By comparison, it was found that: 1) for the CeO₂ series catalysts, the photo-catalytic activity follows the order: CeO₂—ZnO composite NRAs>CeO₂ NTAs>ZnO NRAs; 2) for the SnO₂ series catalysts, the photo-catalytic activity follows the order: SnO₂—ZnO composite NRAs>SnO₂ NTAs>ZnO NRAs; 3) for LSCO series catalysts, the photo-catalytic activity follows the order: LSCO-ZnO composite NRAs>ZnO NRAs˜LSCO NTAs. 4) the photo-catalytic activity for several composite NRAs follows the order: SnO₂—ZnO composite NRAs>CeO₂—ZnO composite NRAs>LSCO-ZnO composite NRAs. However, this comparison involves the contributions from the adsorption of RB on such nanomaterials and thus cannot accurately reflect the catalytic kinetics of such nanomaterials. Therefore, quantitative kinetic information will be obtained by fitting to −ln(C/C₀) (or −ln(A/A₀)) vs. t in the following discussion.

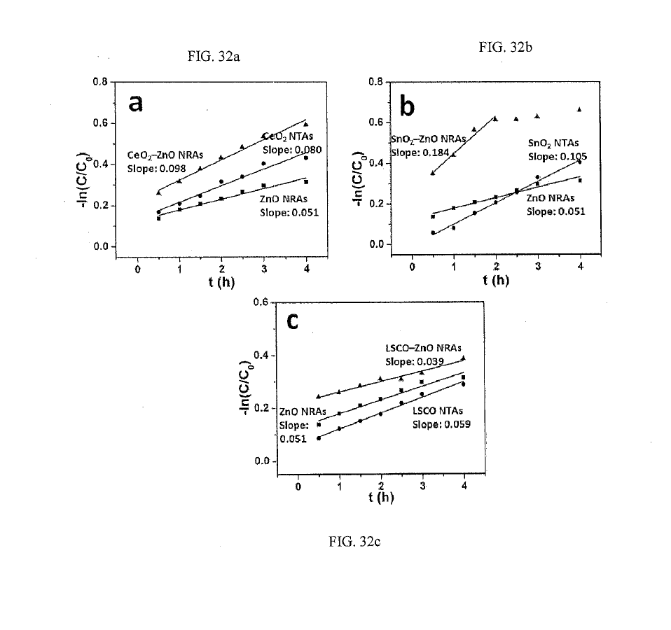

Herein, the ZnO NRAs as a template are the cores of the CeO₂—ZnO, SnO₂—ZnO and LSCO-ZnO composite NRAs, while CeO₂, SnO₂ and LSCO NTAs prepared by the TPR and wet etching methods from these composite NRAs have integrated shells and nearly the same compositions. Therefore, it is feasible to make a comparison among three series of materials to decouple the contributions of cores and shells in the composite NRAs. FIG. 32 shows the plots of −ln(C/C₀) vs. t obtained from the UV-vis absorption spectra of RB after irradiation on three series of materials. As shown in FIG. 32a, the linearity of −ln(C/C₀) vs. t suggests that the degradation of RB follows first order reaction kinetics on ZnO NRAs, CeO₂—ZnO composite NRAs and CeO₂ NTAs. Kansal et al. also found that the photo-catalytic degradation of both RB₅ and RO₄ in aqueous ZnO could be described by the first-order kinetic model. See Kansal, S.; Kaur, N.; Singh, S. Nanoscale Research Letters 2009, 4, 709. It can be found from the slope of the lines in FIG. 32a that the rate constants for the degradation of RB are 0.051 h⁻¹ for the ZnO NRAs, 0.080 h⁻¹ for the CeO₂ NTAs and 0.098 h⁻¹ for the CeO₂—ZnO composite NRAs, respectively. Because both CeO₂ and ZnO are n-type semiconductors, they can be excited under UV light to provide holes for the degradation of RB as photo-catalysts. By comparison, CeO₂ NTAs shells play a more important role in the catalytic performance of the CeO₂—ZnO composite NRAs than ZnO NRAs cores. Moreover, the rate constant for the CeO₂—ZnO composite NRAs is clearly less than the sum of those for ZnO NRAs and CeO₂ NTAs. This means that the synergetic catalytic effect of ZnO cores and CeO₂ shells is not found, which will also be confirmed by the following XPS results. As seen from FIG. 32b, −ln(C/C₀) is linear with t on ZnO NRAs and SnO₂ NTAs in the whole time range, while on SnO₂—ZnO composite NRAs, it is initially linear and then is stabilized slowly. The rate constants for the degradation of RB are 0.051 h⁻¹ for the ZnO NRAs, 0.105 h⁻¹ for the SnO₂ NTAs and 0.184 h⁻¹ for the SnO₂—ZnO composite NRAs, respectively. As such, both SnO₂ and ZnO are n-type semiconductors can be used as photo-catalysts. The SnO₂ NTAs shells have a much higher photo-catalytic performance than ZnO NRAs cores. Moreover, the rate constant for SnO₂—ZnO composite NRAs is clearly higher than the sum of those for ZnO NRAs and SnO₂ NTAs. This means that there exists a synergetic catalytic effect between ZnO cores and SnO₂ shells, which will also be confirmed by the following XPS results. The linearity of −ln(C/C₀) vs. t in FIG. 32c suggests that the degradation of RB also follows first order reaction kinetics on ZnO NRAs, LSCO-ZnO composite NRAs and LSCO NTAs. The rate constants for the degradation of RB are 0.051 h⁻¹ for the ZnO NRAs, 0.059 h⁻¹ for the LSCO NTAs and 0.039 h⁻¹ for the LSCO-ZnO composite NRAs, respectively. The LSCO NTAs shells have a similar photo-catalytic performance as compared to ZnO NRAs cores. However, the photo-catalytic performance of the LSCO-ZnO composite NRAs is even lower than that of either ZnO cores or LSCO shells. This also implies that there is a strong interaction between the cores and shells which adversely affects the photo-catalytic performance. This adverse effect results from the increased recombination rate of electrons and holes in the LSCO-ZnO hetero junction and will be discussed in detail later. By decoupling the photo-catalytic contributions, it was found that the shells in the composite NRAs play an important role in photo-catalysis which depends on the types of materials.

It is impossible to prepare the CeO₂—ZnO, SnO₂—ZnO and LSCO-ZnO composite NRAs with the same surface area. Therefore, their rate constants were normalized with the BET surface area in order to make a kinetic comparison among these composite NRAs. As shown in Table 1, the BET surface area after subtracting the substrates is 0.074 m² for the CeO₂—ZnO composite NRAs, 0.187 m² for the SnO₂—ZnO composite NRAs, and 0.420 m² for the LSCO-ZnO composite NRAs, respectively.

TABLE 1
BET surface area and specific rate constants of the CeO₂—ZnO,
SnO₂—ZnO, LSCO—ZnO composite NRAs

| | CeO₂—ZnO | SnO₂—ZnO | LSCO—ZnO |
|---|---|---|---|
| Sample | NRAs | NRAs | NRAs |
| BET | 0.074 | 0.187 | 0.420 |
| surface area (m²) | | | |
| Rate | 0.098 | 0.184 | 0.039 |
| Constants (h⁻¹) | | | |
| Specific | 1.320 | 0.982 | 0.093 |
| Rate Constants | | | |
| (h⁻¹ m⁻² catalyst) | | | |

Therefore, the specific rate constants are calculated to be 1.320 h⁻² for the CeO₂—ZnO composite NRAs, 0.982 h⁻¹ min⁻² for the SnO₂—ZnO composite NRAs, and 0.093 h⁻¹ min⁻² for the LSCO-ZnO composite NRAs, respectively. As far as the specific rate constants are concerned, the SnO₂—ZnO composite NRAs are a little bit lower than the CeO₂—ZnO composite NRAs. However, both of them are an order of magnitude higher than the LSCO-ZnO composite NRAs. This analysis further confirms that the CeO₂—ZnO and SnO₂—ZnO composite NRAs have much better photo-catalytic performance than the LSCO-ZnO composite NRAs.

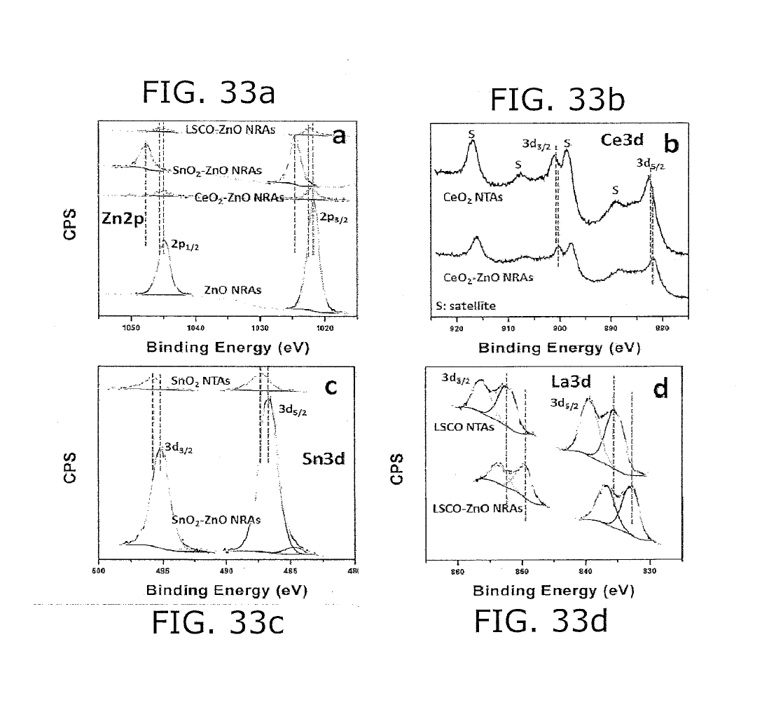

A detailed analysis of XPS and energy band structure is made below in order to explain the difference in the photo-catalytic performance of several composite NRAs, which is very useful for designing high-performance photo-catalysts. FIG. 33 shows the XPS fine spectra of the ZnO NRAs, composite NRAs (CeO₂—ZnO, SnO₂—ZnO and LSCO-ZnO) and NTAs (CeO₂, SnO₂ and LSCO). As shown in FIG. 33a, there is little of Zn(2p) peaks (including Zn(2p)_{1/2} and Zn(2p)_{3/2}) between the CeO₂—ZnO composite NRAs and ZnO NRAs. The Zn(2p) peaks for the SnO₂—ZnO composite NRAs shift by 2.72 eV towards higher binding energy than those for the ZnO NRAs, while they for the LSCO-ZnO composite NRAs shift by 0.61 eV towards higher binding energy than those for the ZnO NRAs. As such, there is also little shifting of Ce(3d) peaks (including Ce(3d)_{3/2} and Ce(3d)_{5/2}) between the CeO₂—ZnO composite NRAs and ZnO NRAs as shown in FIG. 33b. Both Sn(3d) peaks for the SnO₂—ZnO composite NRAs shift by 0.72 eV towards lower binding energy than those for the SnO₂ NTAs (see FIG. 33c), while both La(3d) peaks for the LSCO-ZnO composite NRAs shift by 2.38 eV towards lower binding energy than those for the LSCO NTAs (see FIG. 33d). The Sr(3d) and Co(2p) peaks also have the same trends as La(3d) peaks and therefore are not shown here.

Therefore, it can concluded from the above comparative analysis as follows: 1) no obvious shifting of Zn(2p) and Ce(3d) for the CeO₂—ZnO composite NRAs as compared with the ZnO NRAs and CeO₂ NTAs. This means that there is no obvious change in electron cloud density of Zn and Ce, and thus no obvious interaction between ZnO cores and CeO₂ shells in the CeO₂—ZnO composite NRAs; 2) the positive shifting of Zn(2p) and the negative shifting of Sn(3d) for the SnO₂—ZnO composite NRAs as compared with the ZnO NRAs and SnO₂ NTAs. This indicates that the electron cloud density around the Zn nuclei shifts towards Sn. The obvious shifting means that there exists a strong interaction between ZnO cores and SnO₂ shells in the SnO₂—ZnO composite NRAs; 3) the positive shifting of Zn(2p) and the negative shifting of La(3d), Sr(3d) and Co(2p) for the LSCO-ZnO composite NRAs as compared with the ZnO NRAs and LSCO NTAs. This indicates that the electron cloud density around the Zn nuclei shifts towards LSCO. The clear shifting means that there also exists a strong interaction between ZnO cores and LSCO shells in the LSCO-ZnO composite NRAs. However, this interaction is weaker than that between ZnO cores and SnO₂ shells in the SnO₂—ZnO composite NRAs.

As reported by Xu et al., the band gap (E_{g}) and energy positions (E_{CB} and E_{VB}) for ZnO are 3.20 eV, −4.19 eV and −7.39 eV, respectively, while the E_{g}, E_{CB} and E_{VB} for SnO₂ are 3.50 eV, −4.50 eV and −8.00 eV, respectively. See Xu, Y.; Schoonen, M. A. A. Am. Mineral, 2000, 85, 543. Magesh reported that CeO₂ has an E_{g} of 2.76 eV, E_{CB} of −4.18 eV and E_{VB} of −6.94 eV. See Magesh, G.; Viswanathan, B.; Viswanath, R. P.; Varadarajan, T. K. Indian Journal of Chemistry 2009, 48A, 480. To the Applicants' knowledge, there is no report about the energy band structure of La_{0.8}Sr_{0.2}CoO₃ on Si substrate. Cai et al. proposed that the tensile strained La_{0.8}Sr_{0.2}CoO₃/SrTiO₃ has a larger energy gap (1.5 eV) than the compressively strained La_{0.8}Sr_{0.2}CoO₃/LaAlO₃ (0.8 eV) at room temperature. See Cai, Z.; Kuru, Y.; Han, J. W.; Chen, Y.; Yildiz, B. J. Am. Chem. Soc. 2011, 133, 17696. In this case, the single crystal Si substrate is neither tensile nor compressive. So an average was made and the band gap of La_{0.8}Sr_{0.2}CoO₃ was assumed to be 1.15 eV. As stated in the XPS analysis above, the Zn(2p) peak for the LSCO-ZnO composite NRAs has a half of shifting amount less than that for the SnO₂—ZnO composite NRAs. So one speculates that the E_{CB} of LSCO should be located between ZnO (−4.19 eV) and SnO₂ (−4.50 eV) and be closer to ZnO. Therefore, the E_{CB} of LSCO is assumed to be −4.30 eV. The E_{VB} equals −5.45 eV according to the difference of band gap and E_{CB}. The band gaps and energy positions of ZnO, CeO₂, SnO₂ and LSCO are summarized in Table 2.

TABLE 2
Band gaps and energy positions of ZnO, SnO2, and LSCO

| Materials | E_{CB} (eV) vs. vac | E_{VB} (eV) vs. vac | E_{g} (eV) |
|---|---|---|---|
| ZnO | −4.19 | −7.39 | 3.20 |
| CeO₂ | −4.18 | −6.94 | 2.76 |
| SnO₂ | −4.50 | −8.00 | 3.50 |
| LSCO | −4.30^{b} | −5.45^{c} | 1.15^{a} |

^{a}E_{g} of LSCO on Si substrate is estimated according to Cai et al.
^{b}E_{CB} of LSCO is obtained from XPS analysis for the shifting of Zn(2p) between the LSCO—ZnO and SnO₂—ZnO composite NRAs.
^{c}E_{VB} of LSCO is calculated by the difference of E_{g} and E_{CB.}

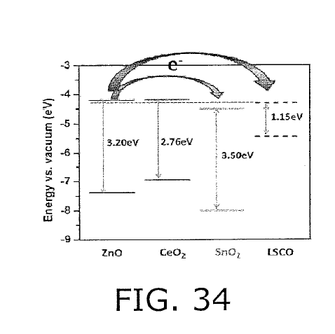

The schematic illustration of the energy band structure of ZnO, CeO₂, SnO₂ and LSCO is depicted in FIG. 34 according to Table 2. ZnO has a similar conductive band position to CeO₂, which means that there is little electron transfer at the interface between ZnO and CeO₂. This is consistent with the XPS results. SnO₂ has lower conductive band and valence band positions than ZnO, that is, SnO₂—ZnO composite NRAs are a Type II alignment hetero-junction. In this system, electrons can transfer from ZnO to SnO₂, which corresponds with the conclusion drawn in XPS that there exists a shifting of an electron cloud around Zn towards Sn. The energy band of ZnO straddles both sides of LSCO, which shows that the LSCO-ZnO composite NRAs are a Type I alignment hetero-junction. As seen from the photo-catalytic results, the presence of CeO₂ and SnO₂ shells promotes the photo-catalytic performance of the ZnO NRAs cores, while the presence of LSCO has an adverse effect on the photo-catalytic performance of the ZnO NRAs cores. This suggests an important correlation among the XPS results, energy band structures and photo-catalytic performance. As is known, in the Type I structure, both an electron and a hole tend to localized within the material with a narrower energy gap. Therefore, the emission energy is determined by band gap width of semiconductor 1 with a narrower band gap. In the Type II structure, the energy gradient tends to spatially separate the electron and the hole on different sides of the hetero-interface. Therefore, the emission energy is determined by the energy difference between the conduction band edge of semiconductor 1 with a narrower band gap and the valence band edge of semiconductor 2 with a wider band gap, and hence, it is lower than the band gap of either semiconductor. See Ivanov, S. A.; Piryatinski, A.; Nanda, J.; Tretiak, S.; Zavadil, K. R.; Wallace, W. O.; Werder, D.; Klimov, V. I. J. Am. Chem. Soc. 2007, 129, 11708. In the present case, a Type II alignment hetero-junction such as SnO₂—ZnO is favorable for the photo-catalysis because it has higher photo-absorption and lower recombination rate of electrons and holes. Type I alignment hetero junction such as LSCO-ZnO is not favorable because both electrons and holes of ZnO cores can simultaneously reach LSCO with a narrow band gap which greatly increases the recombination rate of electrons and holes, and thus counteracts part of the contributions of ZnO to the photo-catalytic activity. In the case of the CeO₂—ZnO composite NRAs, although there is no interaction between CeO₂ shells and ZnO cores, CeO₂ shells can also provide additional holes for the photo-catalytic degradation of RB in addition to ZnO cores and thus partly improves the photo-catalytic performance. After all, SnO₂ has a better synergic effect on ZnO than CeO₂ due to the strong interaction between SnO₂ shells and ZnO cores.

### CONCLUSIONS

ZnO NRAs were obtained by a hydrothermal method, the CeO₂—ZnO, SnO₂—ZnO and LSCO-ZnO composite NRAs by a sputtering method, CeO₂ and LSCO NTAs by a TPR method, and SnO₂ NTAs by a wet etching method. The SEM, EDX, TEM, XRD and XPS survey spectra confirm their nanorod or nanotube array structures. By comparing the photo-catalytic degradation of RB on these separate and composite materials, the contributions of cores and shells in the composite NRAs were decoupled, and the effects of different shells on the photo-catalytic performance of the composite NRAs were investigated. In the CeO₂—ZnO composite NRAs, CeO₂ shells have a slightly bigger contribution than ZnO cores; in the SnO₂—ZnO composite NRAs, SnO₂ shells have a much bigger contribution than ZnO cores; in the LSCO-ZnO composite NRAs, LSCO shells have a similar contribution to ZnO cores. XPS results confirm that there are strong interactions between ZnO cores and SnO₂ shells, and between ZnO cores and LSCO shells, while there is no clear interaction between ZnO cores and CeO₂ shells. This can be correlated well with the energy band structures of ZnO, CeO₂, SnO₂ and LSCO. The analysis of XPS and energy band structures indicates that Type II alignment systems, such as SnO₂—ZnO, are favorable for the photo-catalysis, while Type I alignment systems, such as LSCO-ZnO, increase the recombination probability and thus reduce the photo-catalytic performance. These results provide a design basis for the development of highly efficient composite photo-catalysts.

The relevant teachings of all patents, published applications and references cited herein are incorporated by reference in their entireties.

While this invention has been particularly shown and described with references to example embodiments thereof, it will be understood by those skilled in the art that various changes in form and details may be made therein without departing from the scope of the invention encompassed by the appended claims.

1. A method of making a nanotube array structure comprising:
forming a nanorod array template on a substrate;
coating a nanotube material over the nanorod array template, forming a coated template;
annealing the coated template;
drying the coated template; and
heating the coated template to an elevated temperature, relative to ambient temperature, at a heating rate while flowing a gas mixture including a reducing gas over the substrate at a flow rate, the reducing gas reacting with the nanorod array template and forming a gaseous byproduct and the nanotube array structure.

2. The method of claim 1, wherein heating the coated template further includes maintaining the coated template at the elevated temperature for a heating time.

3. The method of claim 2, wherein the heating time is less than about 5 hours.

4. The method of claim 1, wherein the nanorod array template is a zinc oxide (ZnO) nanorod array template.

5. The method of claim 1, wherein the nanotube material is ceria (CeO₂).

6. The method of claim 1, wherein the nanotube material is LaₓSr₁₋ₓCoO₃ (LSCO) (0.01≦x≦0.5).

7. The method of claim 1, wherein the elevated temperature is in a range of between about 400° C. and about 1,200° C.

8. The method of claim 1, wherein the heating rate is in a range of between about 1° C. and about 25° C. per minute.

9. The method of claim 1, wherein the gas mixture includes a reducing gas in a range of between about 1 vol % and about 20 vol %, with the balance of the gas mixture being composed substantially of nitrogen.

10. The method of claim 9, wherein the reducing gas is hydrogen gas.

11. The method of claim 9, wherein the reducing gas is carbon monoxide (CO) gas.

12. The method of claim 1, wherein the flow rate is in a range of between about 1 sccm and about 100 sccm.

13. The method of claim 1, wherein the substrate is a planar substrate.

14. The method of claim 13, wherein the planar substrate is a silicon substrate.

15. The method of claim 1, wherein the substrate is a monolithic substrate.

16. The method of claim 15, wherein the monolithic substrate is a cordierite substrate.

17. An apparatus, comprising:
a substrate; and
nanotubes coupled to the substrate, at least a subset of the nanotubes being substantially aligned with adjacent nanotubes.

18. The apparatus of claim 17, wherein the nanotubes are offset from and aligned with adjacent nanotubes.

19. The apparatus of claim 17, wherein the nanotubes are substantially vertical with respect to the substrate.

20. The apparatus of claim 17, wherein a spacing of contact locations of the adjacent nanotubes proximal to the substrate is closer than a spacing of ends of nanotubes distal from the substrate to form a non-parallel alignment of the nanotubes offset from and aligned with the adjacent nanotubes.

21. The apparatus of claim 17, wherein the apparatus is selected from a group consisting of a sensor, catalyst, transistor, and solar cell.

22. An apparatus having nanotubes with neighboring alignment, the apparatus made by the process of:
forming a nanorod array template on a substrate;
coating a nanotube material over the nanorod array template, forming a coated template;
annealing the coated template;
drying the coated template; and
heating the coated template to an elevated temperature, relative to ambient temperature, at a heating rate while flowing a gas mixture including a reducing gas over the substrate at a flow rate, the reducing gas reacting with the nanorod array template and forming a gaseous byproduct and the nanotube array structure.

23. The apparatus of claim 22, wherein heating the coated template further includes maintaining the coated template at the elevated temperature for a heating time.

24. The apparatus of claim 23, wherein the heating time is less than about 5 hours.

25. The apparatus of claim 22, wherein the nanorod array template is a zinc oxide (ZnO) nanorod array template.

26. The apparatus of claim 22, wherein the nanotube material is ceria (CeO₂).

27. The apparatus of claim 22, wherein the nanotube material is LaₓSr₁₋ₓCoO₃ (LSCO) (0.01≦x≦0.5).

28. The apparatus of claim 22, wherein the elevated temperature is in a range of between about 400° C. and about 1,200° C.

29. The apparatus of claim 22, wherein the heating rate is in a range of between about 1° C. and about 25° C. per minute.

30. The apparatus of claim 22, wherein the gas mixture includes a reducing gas in a range of between about 1 vol % and about 20 vol %, with the balance of the gas mixture being composed substantially of nitrogen.

31. The apparatus of claim 30, wherein the reducing gas is hydrogen gas.

32. The apparatus of claim 30, wherein the reducing gas is carbon monoxide (CO) gas.

33. The apparatus of claim 22, wherein the flow rate is in a range of between about 1 sccm and about 100 sccm.

34. The apparatus of claim 22, wherein the substrate is a planar substrate.

35. The apparatus of claim 34, wherein the planar substrate is a silicon substrate.

36. The apparatus of claim 22, wherein the substrate is a monolithic substrate.

37. The apparatus of claim 36, wherein the monolithic substrate is a cordierite substrate.
